(19) United States
(12) Patent Application Publication
(10) Pub. No.: US 2016/0234089 A1
(43) Pub. Date: Aug. 11, 2016

(54) WIRELESS COMMUNICATION SYSTEM

(71) Applicant: FUJITSU LIMITED, Kawasaki-shi (JP)

(72) Inventors: Bun Kimura, Yokohama (JP); Kenji Takada, Yokosuka (JP); Toshiyuki ICHINOHE, Kawasaki (JP)

(73) Assignee: FUJITSU LIMITED, Kawasaki-shi (JP)

(21) Appl. No.: 14/992,468

(22) Filed: Jan. 11, 2016

(30) Foreign Application Priority Data
Feb. 5, 2015 (JP) 2015-021213

(51) Int. Cl. H04L 12/26; H04W 72/04; H04W 4/00

(52) U.S. Cl. CPC H04L 43/0847; H04W 4/005; H04W 72/0453

(57) ABSTRACT

A wireless communication system includes a machine to machine (M2M) device, and a base station that performs wireless communication with the M2M device. The M2M device includes a check-signal transmitting unit that transmits, after a bearer in a wireless section between itself and the base station is released, a check signal to the base station every first period by wireless communication using a frequency that is used in the bearer. The base station includes a determining unit and a notifying unit. The determining unit determines whether there is an abnormality in wireless connection between itself and the M2M device based on whether a check signal is received from the M2M device within a second period. The notifying unit notifies, when the determining unit determines that there is an abnormality in the wireless connection between itself and the M2M device, the abnormality to a predetermined notification destination.

### CROSS-REFERENCE TO RELATED APPLICATION

This application is based upon and claims the benefit of priority of the prior Japanese Patent Application No. 2015-021213, filed on Feb. 5, 2015, the entire contents of which are incorporated herein by reference.

### FIELD

The embodiments discussed herein are related to a wireless communication system.

### BACKGROUND

In recent years, with cost reduction for communication devices, the technical development about a machine to machine (M2M) system has been promoted that implements a service by devices connected to a network communicating data with each other without human intervention. As a network used for the M2M system, a wireless network of long term evolution (LTE) or the like, and a wired network of Ethernet (registered trademark) or the like are used.

A wireless network is often more unstable than a wired network. Therefore, if a wireless network is used as a network for the M2M system, it is preferable that when an abnormal condition occurs in the wireless communications of terminals (hereinafter, M2M devices) used in the M2M system, the condition is detected promptly. As a method of detecting an abnormality in communication with an M2M device, there is a method of periodically transmitting a packet to check connection from a device that communicates with an M2M device to the M2M device, and confirming a response thereto, for example. As a protocol for checking connection, for example, an Internet control message protocol (ICMP) and the like are available. The ICMP operates above Internet protocol layers. Prior art examples are disclosed in Japanese National Publication of International Patent Application No. 2013-511916, International Publication Pamphlet No. 2011/135964, Japanese Laid-open Patent Publication No. 2013-118556, and Japanese National Publication of International Patent Application No. 2014-502082.

In a wireless network of LTE and the like, a base station releases a bearer established in a wireless section to a terminal when a predetermined period of time has passed without user data communication with the terminal. When user data communication with the terminal takes place again, the base station establishes a bearer between itself and the terminal to perform communication of the user data. Thus, it is possible to avoid a radio resource from being occupied by a specific terminal, and to use the radio resource effectively.

However, if a packet to check connection is periodically transmitted to an M2M device to check connection in a wireless section with the M2M device by ICMP or the like, when the transmission interval of the packets is short, the bearer between the M2M device and the base station is not released. Thus, the radio resource is occupied by a specific M2M device, and the use efficiency of the radio resource is reduced.

Moreover, when the transmission interval of the packets to check connection is long, a bearer between the M2M device and the base station is released until user data communication occurs, or until the packet to check connection is transmitted, and therefore, the radio resource is used effectively. However, processing of establishing a bearer in the wireless section between the M2M device and the base station is to be performed each time the packet to check connection is transmitted. When a lot of M2M devices communicate through one base station, just the processing to establish a bearer between each M2M device and itself to transmit a packet to check connection causes a heavy processing load on the base station.

### SUMMARY

According to an aspect of an embodiment, a wireless communication system includes a terminal and a base station that performs wireless communication with the terminal. The terminal includes a first transmitting unit. The first transmitting unit transmits, after a bearer between the terminal and the base station is released, a check signal to the base station every first period by wireless communication using a frequency that is used in the bearer. The base station includes a first determining unit and a first notifying unit. The first determining unit determines whether there is an abnormality in wireless connection to the terminal based on whether the check signal is received from the terminal within a second period after the bearer is released. The first notifying unit notifies, when the first determining unit determines that there is an abnormality in the wireless connection to the terminal, the abnormality to a predetermined notification destination.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 depicts one example of a wireless communication system;

FIG. 2 is a block diagram depicting one example of an M2M device;

FIG. 3 depicts one example of terminal setting information that is stored in a setting-information holding unit of the M2M device;

FIG. 4 is a block diagram depicting one example of a base station;

FIG. 5 depicts one example of base-station setting information that is stored in a setting-information holding unit of the base station;

FIG. 6 is a block diagram depicting one example of a Mobility Management Entity (MME);

FIG. 7 depicts one example of setting information that is acquired from a Home Subscriber Server (HSS);

FIG. 8 depicts one example of setting information that is stored in a setting-information holding unit of the MME;

FIG. 9 depicts one example of hardware of the M2M device;

FIG. 10 depicts one example of hardware of the base station;

FIG. 11 depicts one example of hardware of the MME;

FIG. 12 is a sequence diagram depicting one example of operation of the wireless communication system in attach processing;

FIG. 13 is a sequence diagram depicting one example of operation of the wireless communication system at the time of updating setting information;

FIG. 14 is a sequence diagram depicting one example of operation of the wireless communication system in a Data-Radio-Bearer (DRB) unconnected state;

FIG. 15 is a sequence diagram depicting one example of operation of the M2M device when an abnormality in wireless connection is detected;

FIG. 16 is a sequence diagram depicting one example of operation of the base station when an abnormality in wireless connection is detected;

FIG. 17 is a sequence diagram depicting one example of operation of the wireless communication system when the M2M device selects a different sector;

FIG. 18 is a sequence diagram depicting one example of operation of the base station when recovery of the wireless connection is detected;

FIG. 19 is a flowchart indicating one example of operation of the M2M device;

FIG. 20 is a flowchart indicating one example of operation of the M2M device;

FIG. 21 is a flowchart indicating one example of operation of the base station; and

FIG. 22 is a flowchart indicating one example of operation of the base station.

### DESCRIPTION OF EMBODIMENTS

Preferred embodiments of the present invention will be explained with reference to accompanying drawings. Note that the disclosed technique is not limited to the following embodiments. Respective embodiments can be combined appropriately in a range not making processing inconsistent.

Wireless Communication System

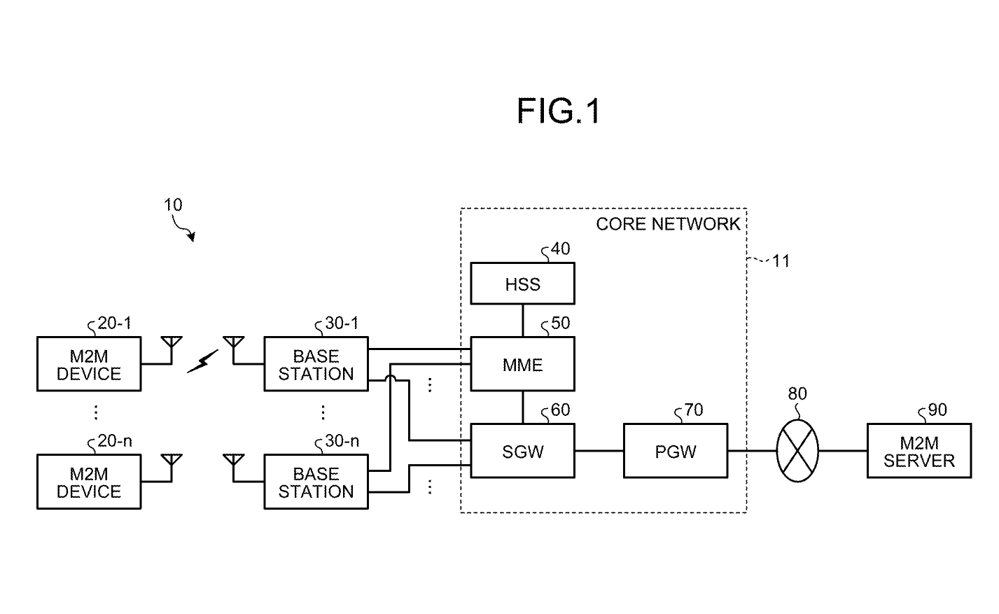

FIG. 1 depicts one example of a wireless communication system 10. The wireless communication system 10 includes, for example, multiple M2M devices 20-1 to 20-n, multiple base stations 30-1 to 30-n, and a core network 11, as depicted in a FIG. 1. In the following, when the M2M devices 20-1 to 20-n are collectively referred without distinguishing each, it is described as M2M device 20. Moreover, when the base stations 30-1 to 30-n are referred collectively without distinguishing each, it is described as base station 30. The core network 11 is connected to an M2M server 90 through an Internet protocol (IP) network 80. Each of the M2M device 20 is connected to the M2M server 90 through the base station 30 and the core network 11. The wireless communication system 10 is constructed, for example, using a wireless network of LTE and the like.

The respective M2M device 20 and the respective base station 30 are connected by a wireless link. When the M2M device 20 communicates with the M2M server 90, a part of radio resources that can be provided by the base station 30 is reserved for the M2M device, thereby enabling communication between the M2M device 20 and the M2M server 90 through the base station.

The M2M device 20 is one example of a terminal that performs wireless communication with the base station 30. The M2M device 20 is, for example, a power usage meter having a wireless communication function, a vending machine having wireless communication function, and the like. The M2M device 20 acquires information about a power usage amount and the like based on information received from the M2M server 90 through the base station 30, and transmits the acquired information to the M2M server 90 through base station 30 and the core network 11. Moreover, the M2M server 90 controls the respective M2M devices 20 by transmitting control information to the respective M2M devices 20 through the core network 11 and the base station 30.

The core network 11 includes an HSS 40, an MME 50, a serving gateway (SGW) 60, and a packet data network gateway (PGW) 70. The MME 50 is one example of a management unit.

The HSS 40 manages subscriber information (for example, terminal information, verification information, and the like) in the wireless communication system 10, setting information described later, and the like. The MME 50 holds more than one base station 30, and performs mobility management of terminals, such as the M2M devices 20. The SGW 60 performs processing of packet transfer in the core network 11, and the like. The PGW 70 performs processing of packet transfer between the core network 11 and an external network, and the like.

M2M Device

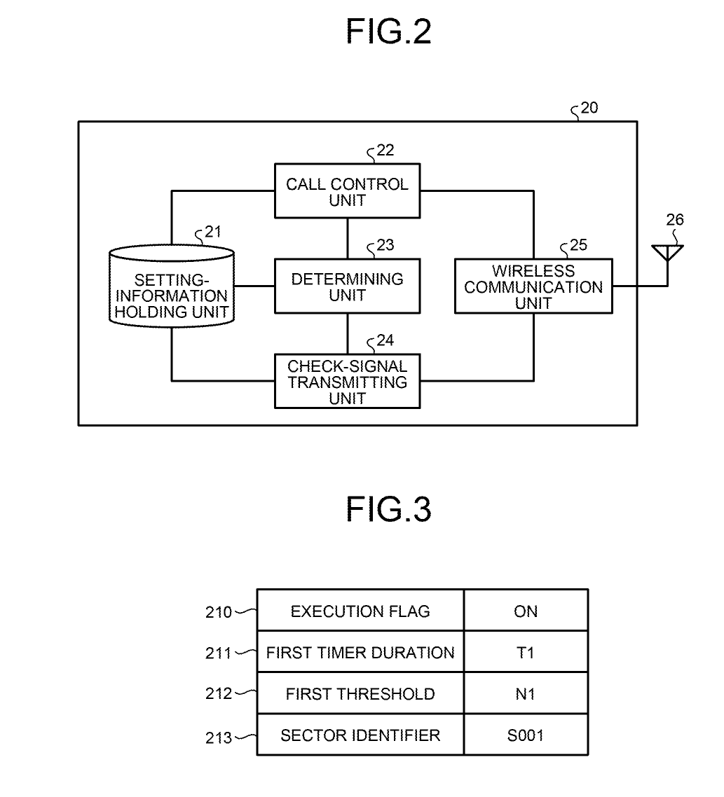

FIG. 2 is a block diagram depicting one example of the M2M device 20. The M2M device 20 includes, for example, a setting-information holding unit 21, a call control unit 22, a determining unit 23, a check-signal transmitting unit 24, a wireless communication unit 25, and an antenna 26, as depicted in FIG. 2.

The wireless communication unit 25 performs processing such as encoding and modulation on a signal input from the call control unit 22 and the check-signal transmitting unit 24, upconverts the signal subjected to the processing to a predetermined frequency, to transmit to the base station 30 through the antenna 26. Moreover, the wireless communication unit 25 downconverts a signal received from the base station 30 through the antenna 26, and performs processing such as demodulation and decoding, to output the signal subjected to the processing to the call control unit 22 and the check-signal transmitting unit 24.

The call control unit 22 performs attach processing between itself and the base station 30 by selecting a sector of the base station 30 based on notification information transmitted from the sector of the base station 30, and by transmitting and receiving a predetermined signal to and from the selected sector. Furthermore, the call control unit 22 receives terminal setting information from the base station 30 through a DRB that is established by the attach processing in a wireless section to the base station 30, and stores the received terminal-setting information in the setting-information holding unit 21.

The terminal setting information stored in the setting-information holding unit 21 includes information that is used for the processing (hereinafter, connection check processing) to check connection in the wireless section between the M2M device 20 and the base station 30 after the DRB between the M2M device 20 and the base station 30 is released. FIG. 3 depicts one example of the terminal setting information that is stored in the setting-information holding unit 21 of the M2M device 20. The terminal setting information stored in the setting-information holding unit 21 includes, for example, an execution flag 210, a first timer duration 211, a first threshold 212, and a sector identifier 213, as indicated in FIG. 3.

The execution flag 210 is information that controls whether to execute the connection check processing. When the execution flag 210 is set to “ON”, the connection check processing is performed, and when the execution flag 210 is set to “OFF”, the connection check processing is not performed. The first timer duration 211 indicates duration of a first timer that measures a cycle of transmitting a signal to check connection to the base station 30. In the present embodiment, the duration of the first timer is, for example, about several hundred milliseconds.

The first threshold 212 indicates a threshold to determine whether there is an abnormality in wireless connection. When the number of times the connection check processing has not finished normally is equal to or more than the first threshold, the call control unit 22 performs sector selecting processing to search for a different sector. In the present embodiment, the first threshold is, for example, five. The sector identifier 213 is information to identify a sector of the base station 30 to be a destination of a signal to check wireless connection in the connection check processing.

Explanation is continued, referring back to FIG. 2. The call control unit 22 releases the DRB when user data communication has not occurred for a predetermined time since the DRB is established between the M2M device 20 and the base station 30, and informs release of the DRB to the determining unit 23. Moreover, when user data communication occurs between the M2M device 20 and the base station 30 after the DRB is released, the call control unit 22 performs processing to establish the DRB again between itself and the base station 30 by transmitting and receiving predetermined signals to and from the base station 30. When the DRB is established, the call control unit 22 informs establishment of the DRB to the determining unit 23.

Moreover, the call control unit 22 reselects a sector based on the quality of a signal transmitted from a sector of base station 30 when reselection of a sector is instructed by the determining unit 23. The call control unit 22 performs, when a different sector having higher signal quality than the sector of a subject of the connection check processing is selected, the processing to establish a DRB between itself and the base station 30 through the different sector. The determining unit 23 stores terminal setting information that is received from the base station 30 through the different sector in the setting-information holding unit 21. The call control unit 22 notifies the determining unit 23 of establishment of the DRB. On the other hand, when a different sector is not selected, the call control unit 22 notifies the determining unit 23 that a different sector is not selected.

The check-signal transmitting unit 24 reads a sector identifier from the terminal setting information in the setting-information holding unit 21 when transmission of a check signal is instructed by the determining unit 23. The check-signal transmitting unit 24 transmits a check signal to check wireless connection with the base station 30 to the sector identified by the read sector identifier by wireless communications using a frequency used by the DRB between itself and the base station 30. In the present embodiment, the check-signal transmitting unit 24 uses a signal that is used in a random access procedure in LTE as the check signal. Note that as long as it is a signal that enables to check wireless connection with the base station 30, the check-signal transmitting unit 24 may use signals other than the signal that is used in the random access procedure in LTE as the check signal.

For example, the check-signal transmitting unit 24 transmits RA Preamble to the base station 30 that has the sector corresponding to the sector identifier set in the terminal setting information. When RA Response is received from base station 30 as a response to RA Preamble, the check-signal transmitting unit 24 transmits Scheduled Transmission that includes a terminal identifier to identify the M2M device 20, and a connection-check identifier indicating that it is a connection check signal, to the base station 30. RA Response is one example of the first signal. Scheduled Transmission including the terminal identifier and the connection-check identifier is one example of the check signal.

When Contention Resolution is received from the base station 30, the check-signal transmitting unit 24 informs the determining unit 23 that a response signal is received, if the terminal identifier and the connection-check identifier included in Scheduled Transmission are included in received Contention Resolution. Contention Resolution including the terminal identifier and the connection-check identifier is one example of the response signal.

When informed of release of the DRB from the call control unit 22, the determining unit 23 reads the terminal setting information in the setting-information holding unit 21. Furthermore, when the execution flag is set to “ON” that indicates execution of the connection check processing, the determining unit 23 resets and starts the first timer, and instructs the check-signal transmitting unit 24 to transmit a check signal.

The determining unit 23 determines whether there is an abnormality in wireless connection between itself and the base station 30 based on whether a response signal is received from the base station 30 before the first timer times out. A period from start until timeout of the first timer from reset-start of the first timer is one example of a first period.

For example, the determining unit 23 resets the number of errors, which indicates the number of times that the connection check processing is not normally finished with the base station 30, to 0 when informed that a response signal is received from the check-signal transmitting unit 24 before the first timer times out. The determining unit 23 then resets and starts the first timer.

On the other hand, the determining unit 23 increments the number of errors when not informed that a response signal is received from the check-signal transmitting unit 24 until the first timer times out. When the number of errors is equal to or more than the first threshold included in the terminal setting information, the determining unit 23 determines that there is an abnormality in wireless connection to the base station 30. The determining unit 23 then instructs the call control unit 22 to reselect a sector.

Base Station

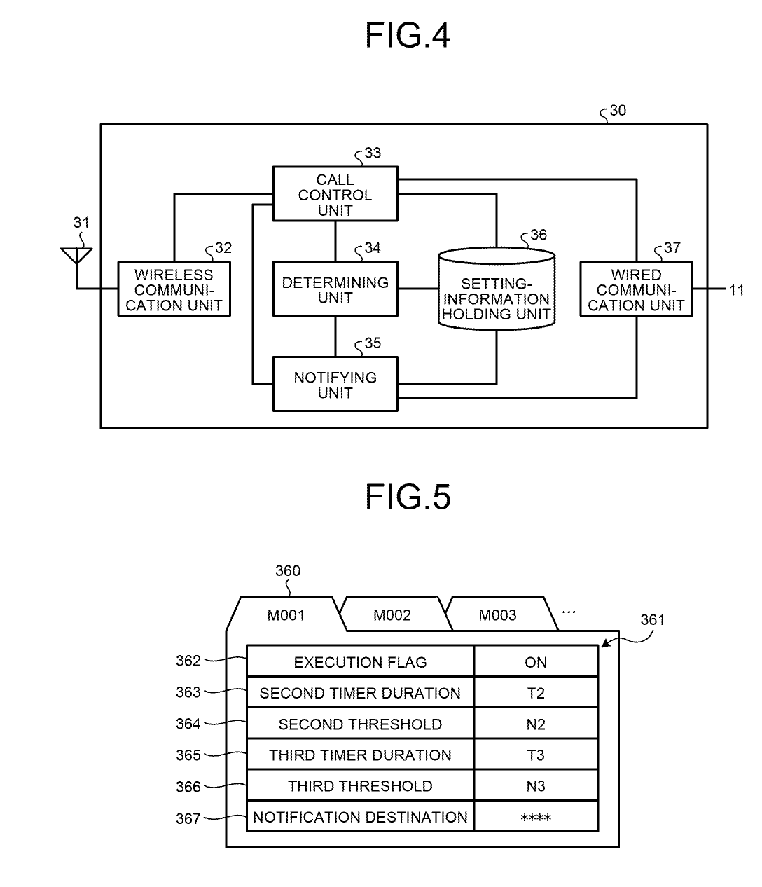

FIG. 4 is a block diagram depicting one example of the base station 30. The base station 30 includes, for example, an antenna 31, a wireless communication unit 32, a call control unit 33, a determining unit 34, a notifying unit 35, a setting-information holding unit 36, and a wired communication unit 37, as depicted in FIG. 4.

The wireless communication unit 32 performs processing such as encoding and modulation on a signal that is input from the call control unit 33, and upconverts the signal subjected to the processing to a predetermined frequency, to transmit to the M2M device 20 through the antenna 31 of a sector. Furthermore, the wireless communication unit 32 downconverts a signal received from the M2M device 20 through the antenna 31 of the sector, and performs processing such as demodulation and decoding, to output the signal subjected to the processing to the call control unit 33.

The wired communication unit 37 is connected to the core network 11. The wired communication unit 37 transmits data input from the call control unit 33 and the notifying unit 35 to the core network 11. Moreover, the wired communication unit 37 outputs data received from the core network 11 to the call control unit 33.

The call control unit 33 transmits notification information per sector through the wireless communication unit 32. Furthermore, the call control unit 33 performs attach processing by transmitting and receiving a predetermined signal among the M2M device 20, the HSS 40, the MME 50, the SGW 60, and the PGW70. Thus, a DRB is established in a wireless section between the base station 30 and the M2M device 20, and an S1 bearer is established in a wired section among the base station 30, the MME 50, and the SGW 60.

The call control unit 33 receives setting information from the MME 50 through the S1 bearer. The setting information includes terminal setting information and base-station setting information. The call control unit 33 stores the base-station setting information included in the setting information in the setting-information holding unit 36. Moreover, the call control unit 33 adds an identifier of the sector that is used to establish the DRB to the terminal setting information included in the setting information. The call control unit 33 then transmits the terminal setting information to which the identifier of the sector is added to the M2M device 20 through the DRB. The call control unit 33 then informs the notifying unit 35 of establishment of a bearer together with a terminal identifier of the M2M device 20 for which the bear is established.

The base-station setting information stored in the setting-information holding unit 36 includes information that is used for the connection check processing performed after the DRB between the M2M device 20 and the base station 30 is released. FIG. 5 depicts one example of the base-station setting information that is stored in the setting-information holding unit 36 of the base station 30. The setting-information holding unit 36 holds, for example, setting information 361 associating with a terminal identifier 360 to identify each of the M2M devices 20 as depicted in FIG. 5. The setting information 361 includes an execution flag 362, a second timer duration 363, a second threshold 364, a third timer duration 365, a third threshold 366, and a notification destination 367.

The execution flag 362 is information to control whether to execute the connection check processing. The second timer duration 363 indicates duration of a second timer that measures a cycle of determining whether there is an abnormality in wireless connection in the connection check processing at the base station 30. The duration of the second timer is longer than that of the first timer and, for example, about several ten seconds to several minutes. The second threshold 364 indicates a threshold to determine whether there is an abnormality in wireless connection in the base station 30. When the number of times the connection check processing has not finished normally is equal to or more than the second threshold, the notifying unit 35 transmits a connection state notification that indicates that there is an abnormality in the wireless connection with the M2M device 20, to a device that is specified by information indicated in the notification destination 367. In the present embodiment, the second threshold is, for example, five.

The third timer duration 365 indicates duration of a third timer that measures a cycle of determining whether there is a recovery of connection in the connection check processing at the base station 30. In the present embodiment, the duration of the third timer is, for example, about several seconds. The third threshold 366 indicates a threshold to determine whether there is a recovery of connection. When the number of times that the connection check processing has been finished normally is equal to or more than the third threshold, the notifying unit 35 transmits a connection state notification indicating that the wireless connection to the M2M device 20 has been recovered, to a device that is specified by information indicated in the notification destination 367. In the present embodiment, the third threshold is, for example, 10. The notification destination 367 is information to identify a device to be a notification destination of the connection state notification, and is, for example, an IP address, or the like.

Explanation is continued referring back to FIG. 4. The call control unit 33 releases the S1 bearer and the DRB when user data communication has not occurred for a predetermined time since the S1 bearer and the DRB are established. The call control unit 33 then informs the determining unit 34 of the release of the bearers together with the terminal identifier of the M2M device 20 for which the bearers have been released. Subsequently, when receiving a check signal from the M2M device 20 for which the S1 bearer and the DRB have been released, the call control unit 33 informs the determining unit 34 of reception of the check signal.

For example, after the S1 bearer and the DRB are released, the call control unit 33 transmits, when RA Preamble is received from the M2M device 20, RA Response to the M2M device 20 as a response to RA Preamble. Subsequently, when Scheduled Transmission is received from the M2M device, the call control unit 33 determines whether a connection check identifier indicating that it is a connection check signal is included in Scheduled Transmission. When a connection check identifier is included in Scheduled Transmission, the call control unit 33 informs the determining unit 34 of reception of the check signal.

Subsequently, the call control unit 33 acquires the terminal identifier and the connection check identifier from received Scheduled Transmission, and creates Contention Resolution holding the acquired terminal identifier and connection check identifier. The call control unit 33 transmits the created Contention Resolution to the M2M device 20.

Moreover, when user data communication occurs between the base station 30 and the M2M device 20 after the S1 bearer and the DRB are released, the call control unit 33 performs processing to establish the S1 bearer and the DRB. When the S1 bearer and the DRB are established, the call control unit 33 informs the determining unit 34 and the notifying unit 35 of establishment of the bearers together with the terminal identifier of the M2M device 20 for which the bearers have been established.

Furthermore, when a deletion instruction including terminal identifier of the M2M device 20 is received from the MME 50, the call control unit 33 deletes base-station setting information that is associated with the terminal identifier included in the deletion instruction from the setting-information holding unit 36.

When informed of the release of the bearer from by the call control unit 33, the determining unit 34 reads the base-station setting information that is associated with the terminal identifier of the M2M device 20 for which the bearer has been released from the setting-information holding unit 36. When the execution flag is set to “ON” indicating execution of the connection check processing, the determining unit 34 resets and starts the second timer having the duration set in the base-station setting information.

The determining unit 34 starts determination whether there is an abnormality in wireless link with the M2M device 20 based on whether a check signal is received from the M2M device 20 before the second timer times out. A period from reset and start until timeout of the second timer is one example of a second period.

For example, the determining unit 34 resets the number of errors, which indicates the number of times that the connection check processing is not normally finished, to 0 when informed that a check signal is received from the call control unit 33 before the second timer times out, and resets and starts the second timer. On the other hand, the determining unit 34 increments the number of errors when not informed that a check signal is received from the call control unit 33 before the second timer times out, and resets and starts the second timer.

When the number of errors is equal to or more than the second threshold included in the base-station setting information, the determining unit 34 determines that there is an abnormality in wireless connection between itself and the base station 30, and informs the notifying unit 35 of abnormal connection together with the terminal identifier of the M2M device 20.

Subsequently, the determining unit 34 starts determination whether the wireless connection of the wireless link with the M2M device 20 has been recovered based on whether a check signal is received from the M2M device 20 before the third timer times out.

For example, when not informed that a check signal is received from the call control unit 33 before the third timer times out, the determining unit 34 resets the number of successes, which indicates the number of times that the connection check processing is normally finished, to 0, and resets and starts the third timer again. On the other hand, when informed that a check signal is received from the call control unit 33 before the third timer times out, the determining unit 34 increments the number of successes, and resets and starts the third timer again.

When the number of successes is equal to or more than the third threshold included in the base-station setting information, the determining unit 34 determines that the wireless link to the base station 30 has been recovered from the abnormal connection, and informs the notifying unit 35 of the connection recovery together with the terminal identifier of the M2M device 20.

When informed of the establishment of a bearer by the call control unit 33 together with the terminal identifier, the notifying unit 35 reads information that is associated with the terminal identifier from the setting-information holding unit 36, and acquires information of a notification destination from the read base-station setting information. The notifying unit 35 then transmits a connection state notification that indicates that the bearer has been established, to a device that is identified by the acquired information of the notification destination through the wired communication unit 37.

Moreover, when informed of the abnormal connection by the determining unit 34 together with the terminal identifier, the notifying unit 35 reads information that is associated with the terminal identifier from the setting-information holding unit 36, and acquires information of a notification destination from the read base-station setting information. The notifying unit 35 then transmits a connection state notification that indicates the abnormal connection, to a device that is identified by the acquired information of the notification destination through the wired communication unit 37.

Furthermore, when informed of connection recovery by the determining unit 34 together with the terminal identifier, the notifying unit 35 reads base-station setting information that is associated with the terminal identifier from the setting-information holding unit 36, and acquires information of a notification destination from the read base-station setting information. The notifying unit 35 then transmits a connection state notification that indicates the connection recovery, to a device that is identified by the acquired information of the notification destination through the wired communication unit 37.

MME

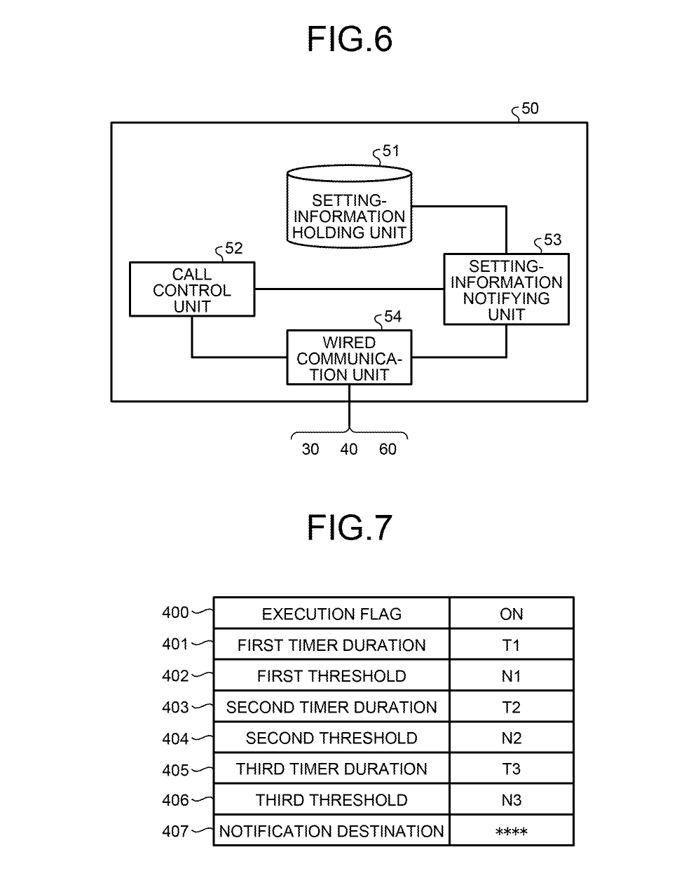

FIG. 6 is a block diagram depicting one example of the MME 50. The MME 50 includes, for example, a setting-information holding unit 51, a call control unit 52, a setting-information notifying unit 53, and a wired communication unit 54, as depicted in FIG. 6.

The wired communication unit 54 is connected to the base station 30, the HSS 40, and the SGW 60. The wired communication unit 54 transmits data input by the call control unit 52 and the setting-information notifying unit 53 to the base station 30, the HSS 40, and the SGW 60. Moreover, the wired communication unit 54 outputs data received from the base station 30, the HSS 40, and the SGW 60 to the call control unit 52 and the setting-information notifying unit 53.

The call control unit 52 performs processing such as attach, bearer establishment, and mobility management of terminals. Furthermore, when attach or bearer establishment processing is completed, the call control unit 52 informs the terminal identifier of the M2M device 20 for which the attach or bearer establishment processing has been performed, and the base station identifier of the base station 30, and of completion of the attach or bearer establishment processing, to the setting-information notifying unit 53.

When informed of completion of the attach processing by the call control unit 52, the setting-information notifying unit 53 acquires setting information of the M2M device 20 for which the attach processing has been performed from the HSS 40. FIG. 7 depicts one example of setting information that is acquired from the HSS 40. The setting information acquired from the HSS 40 includes, for example, an execution flag 400, a first timer duration 401, a first threshold 402, a second timer duration 403, a second threshold 404, a third timer duration 405, a third threshold 406, and a notification destination 407, as indicated in FIG. 7. The setting information from the execution flag 400 to the notification destination 407 indicated in FIG. 7 are set in a database included in the HSS 40 by a terminal of an administrator of the HSS 40, the M2M server 90, or the like.

The execution flag 400 is information that controls whether to execute the connection check processing. The first timer duration 401 indicates duration of a first timer that is used in the connection check processing at the M2M device 20. The first threshold 402 is a threshold that is used in the connection check processing at the M2M device 20. The execution flag 400, the first timer duration 401, and the first threshold 402 are one example of the terminal setting information.

The second timer duration 403 is duration of a second timer that is used in the connection check processing at the base station 30. The second threshold 404 is a threshold that is used in the connection check processing at the base station 30. The third timer duration 405 is duration of a third timer that is used in the connection check processing at the base station. The third threshold is a threshold that is used in the connection check processing at the base station 30. The notification destination 407 is information to identify a device to be a notification destination of a connection state notification. The execution flag 400, the second timer duration 403, the second threshold 404, the third timer duration 405, the third threshold 406, and the notification destination 407 are one example of the base-station setting information.

Explanation is continued referring back to FIG. 6. The setting-information notifying unit 53 transmits the setting information acquired from the HSS 40 together with the terminal identifier of the M2M device 20 for which the attach processing has been performed, to the base station 30 for which the attach processing has been performed. The setting-information notifying unit 53 then adds the base-station identifier of the base station 30 for which the attach processing has been performed to the setting information acquired from the HSS 40, as the base-station identifier of the base station 30 for which the connection check processing is to be performed. Subsequently, the setting-information notifying unit 53 stores the setting information to which the base-station identifier is added in the setting-information holding unit 51, associating with the terminal identifier of the M2M device 20 for which the attach processing has been performed.

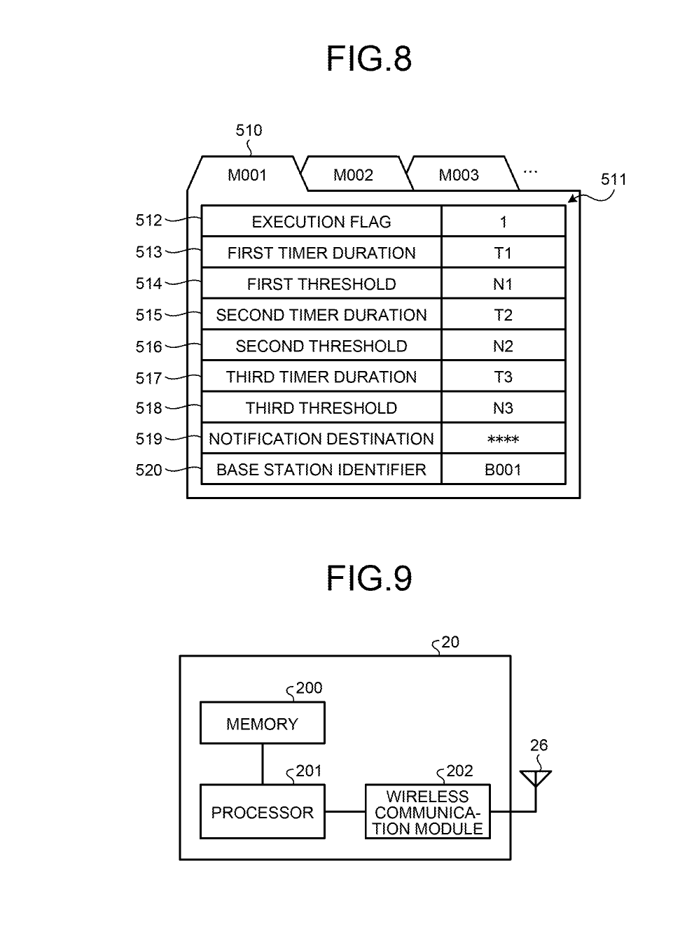

FIG. 8 depicts one example of setting information that is stored in the setting-information holding unit 51 of the MME 50. The setting-information holding unit 51 holds setting information 511 associating with terminal identifiers 510 to identify the respective M2M devices 20, for example, as depicted in FIG. 8. The setting information 511 includes an execution flag 512, a first timer duration 513, a first threshold 514, a second timer duration 515 a second threshold 516, a third timer duration 517, a third threshold 518, a notification destination 519, and a base station identifier 520.

In the setting information 511, information from the execution flag 512 to the notification destination 519 are the same as the information of the execution flag 400 to the notification destination 407 in the setting information acquired from the HSS 40, and therefore, explanation thereof is omitted. The base station identifier 520 is information to identify the base station 30 for which the M2M device 20 performs the connection check processing.

Explanation is continued referring back to FIG. 6. When informed of completion of bearer establishment by the call control unit 52, the setting-information notifying unit 53 identifies setting information that is associated with the terminal identifier of the M2M device 20 informed by the call control unit 52 together with completion of bearer establishment, in the setting-information holding unit 51. Subsequently, the setting-information notifying unit 53 determines whether the base station identifier of the base station 30 informed by the call control unit 52 together with completion of bearer establishment is included in the identified setting information.

When the base station identifier of the base station 30 informed by the call control unit 52 is not included in the setting information, the setting-information notifying unit 53 transmits a deletion instruction together with notification of completion of bearer establishment, to the base station 30 of the base station identifier in the setting information. In the deletion instruction, the terminal identifier of the M2M device 20 informed by the call control unit 52 is included.

The setting-information notifying unit 53 acquires setting information of the M2M device 20 that has performed the bearer establishment processing from the HSS 40. The setting-information notifying unit 53 then transmits the setting information acquired from the HSS 40 to the base station 30 that has performed bearer establishment processing together with the terminal identifier of the M2M device 20 that has performed the bearer establishment processing. Subsequently, the setting-information notifying unit 53 adds the base station identifier of the base station 30 that has performed the bearer establishment processing to the setting information acquired from the HSS 40 as the base station identifier of the base station 30 that is to perform the connection check processing. The setting-information notifying unit 53 then stores the setting information to which the base station identifier of the base station 30 is added in the setting-information holding unit 51 associating with the terminal identifier of the M2M device that has performed the bearer establishment processing.

Hardware

Subsequently, hardware of the M2M device 20, the base station 30, and the MME 50 is explained. FIG. 9 depicts one example of hardware of the M2M device 20. The M2M device 20 includes a memory 200, a processor 201, a wireless communication module 202, and the antenna 26, for example, as depicted in FIG. 9. The call control unit 22, the determining unit 23, and the check-signal transmitting unit 24 are implemented by, for example, the processor 201 such as a central processing unit (CPU) and a digital signal processor (DSP). The wireless communication unit 25 is implemented by, for example, the processor 201 and the wireless communication module 202. The setting-information holding unit 21 is implemented by, for example, the memory 200 such as a random access memory (RAM), a read only memory (ROM), and a flash memory.

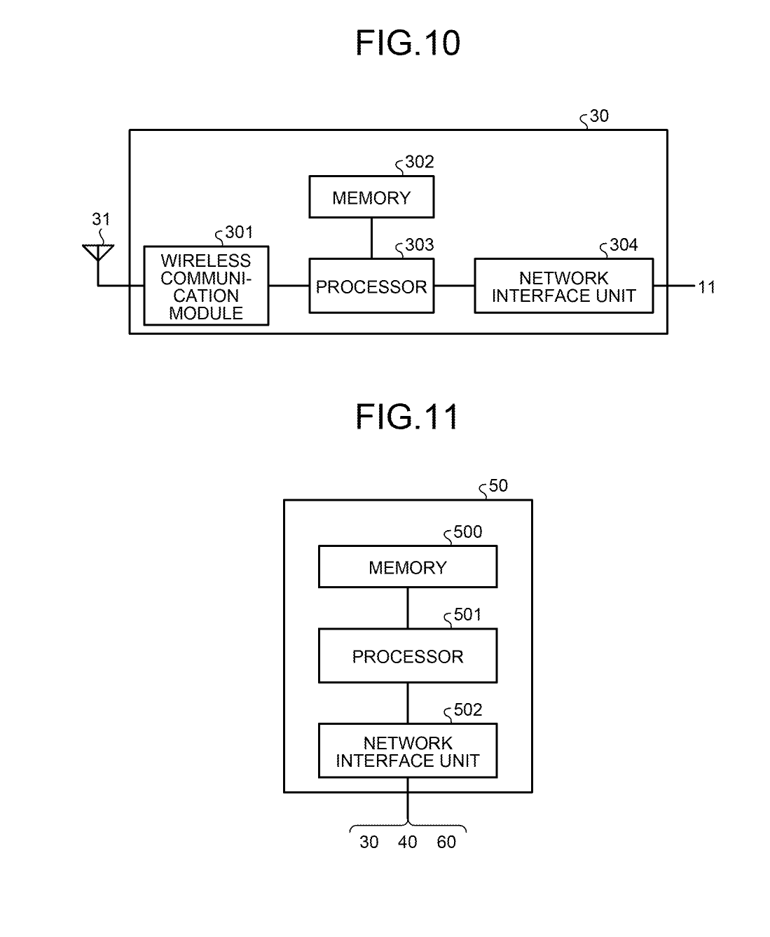

FIG. 10 depicts one example of hardware of the base station 30. The base station 30 includes the antenna 31, a wireless communication module 301, a memory 302, a processor 303, and a network interface unit 304, for example, as depicted in FIG. 10. The call control unit 33, the determining unit 34, and the notifying unit 35 are implemented by, for example, the processor 303 such as a CPU and a DSP. The wireless communication unit 32 is implemented by, for example, the processor 303 and the wireless communication module 301. The setting-information holding unit 36 is implemented by, for example, the memory 302 such as a RAM, a ROM, and a flash memory. The wired communication unit 37 is implemented by, for example the processor 303 and the network interface unit 304.

FIG. 11 depicts one example of hardware of the MME 50. The MME 50 includes a memory 500, a processor 501, and a network interface unit 502, for example, as depicted in FIG. 11. The call control unit 52 and the setting-information notifying unit 53 are implemented by, for example the processor 501 such as a CPU and a DSP. The setting-information holding unit 51 is implemented by the memory 500 such as a RAM, a ROM, and a flash memory. The wired communication unit 54 is implemented by, for example, the processor 501 and the network interface unit 502.

Operation of Wireless Communication System

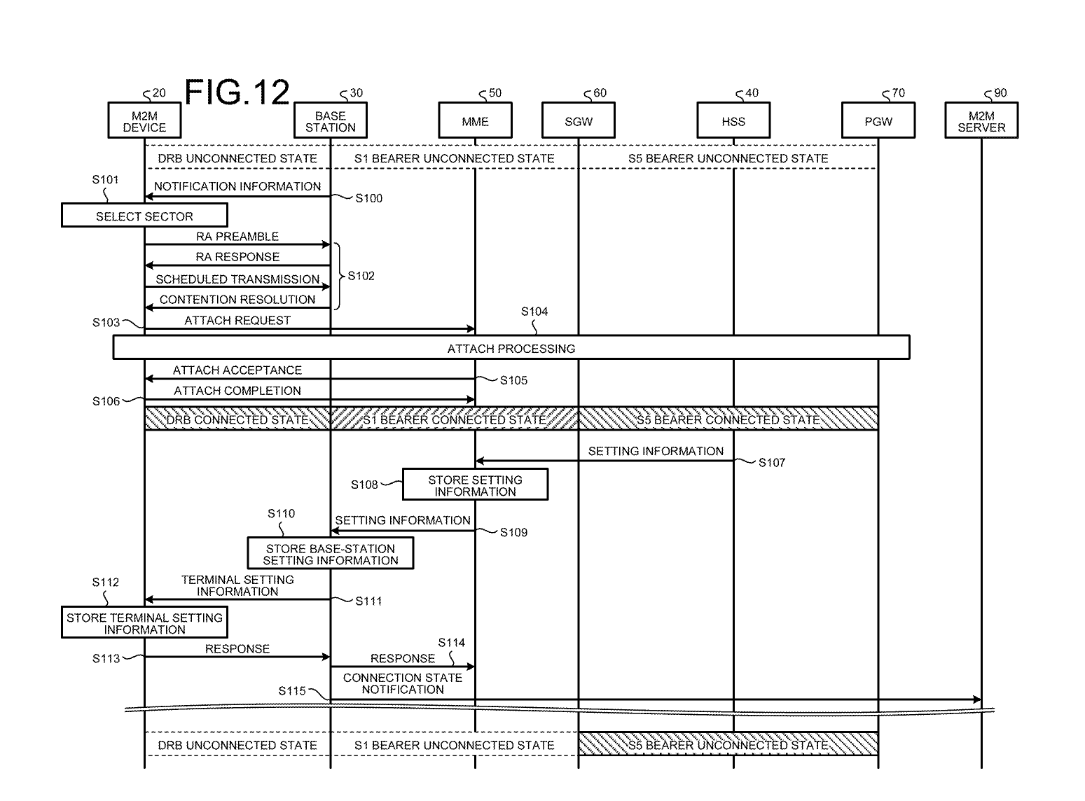

Next, operation of the wireless communication system 10 is explained. FIG. 12 is a sequence diagram depicting one example of operation of the wireless communication system 10 in attach processing. In the following sequence diagram, a case of a single unit of the M2M device 20 is explained. The sequence diagram starts in a state in which the DRB between the M2M device 20 and the base station 30, the S1 bearer among the base station 30, the MME 50, and the SGW 60, and an S5 bearer among the SGW 60, the HSS 40, and the PGW 70 are unconnected.

First, the call control unit 33 of the base station 30 transmits a notification information per sector (S100). The call control unit 22 of the M2M device 20 selects a sector based on the quality of a signal of the notification information transmitted from the base station 30 (S101). The call control unit 22 of the M2M device 20 and the call control unit 33 of the base station 30 execute an initial access procedure, according to LTE random access procedure (S102). In the initial access procedure, the call control unit 22 of the M2M device 20 transmits RA Preamble to the selected sector. The call control unit 33 of the base station 30 transmits RA Response to the M2M device 20 as a response to RA Preamble. The call control unit 22 of the M2M device 20 transmits Scheduled Transmission including a radio-resource-control (RRC) connection-request message to the base station 30. The call control unit 33 of the base station 30 transmits Contention Resolution including an RRC connection-setup message to the M2M device 20.

Subsequently, the call control unit 22 of the M2M device 20 transmits an attach request to the MME 50 through the base station 30 (S103). The attach processing is then performed among the M2M device 20, the base station 30, the MME 50, the SGW 60, the HSS 40, and the PGW 70 (S104). In the attach processing, processing such as verification, concealment, integrality control, position registration, and bearer establishment is performed. The call control unit 52 of the MME 50 transmits an attach acceptance to the M2M device 20 through the base station 30 (S105). The call control unit 22 of the M2M device 20 transmits attach completion to the MME 50 through the base station 30 (S106). Thus, the DRB is established between the M2M device 20 and the base station 30, the S1 bearer is established among the base station 30, the MME 50, and the SGW 60, and the S5 bearer is established between the SGW 60 and the PGW 70.

Subsequently, the setting-information notifying unit 53 of the MME 50 acquires setting information of the M2M device 20 from the HSS 40 (S107). The setting-information notifying unit 53 adds the base station identifier of the base station 30 that has performed the attach processing to the setting information acquired from the HSS 40, and stores the setting information in the setting-information holding unit 51 associating with the terminal identifier of the M2M device 20 that has performed the attach processing (S108). The setting-information notifying unit 53 transmits the setting information acquired from the HSS 40 to the base station 30 that has performed the attach processing, together with the terminal identifier of the M2M device 20 that has performed the attach processing (S109).

The call control unit 33 of the base station 30 stores the base-station setting information that is included in the setting information received from the MME 50, in the setting-information holding unit 36 (S110). The call control unit 33 then adds the identifier of the sector that has been used to establish the DRB to the terminal setting information included in the setting information received from the MME 50. The call control unit 33 transmits the terminal setting information to which the identifier of the sector is added, to the M2M device 20 through the DRB (S111).

The call control unit 22 of the M2M device 20 stores the terminal setting information received from the base station 30 in the setting-information holding unit 21 (S112). The call control unit 22 transmits a response indicating completion of storage of the terminal setting information to the base station 30 (S113). The call control unit 33 of the base station 30 transmits a response indicating completion of storage of the base-station setting information to the MME 50 (S114). The call control unit 33 then informs the notifying unit 35 of establishment of the bearer together with the terminal identifier of the M2M device 20. The notifying unit 35 acquires information of a notification destination that is associated with the terminal identifier of the M2M device 20 from the setting-information holding unit 36, and transmits a connection state notification indicating the establishment of the bearer to the device that is identified by the acquired information (the M2M server 90 in the present embodiment) (S115).

When user data communication has not occurred for a predetermined period between the M2M device and the base station 30, the DRB between the M2M device 20 and the base station 30 and the S1 bearer among the base station 30, the MME 50, and the SGW 60 are released. Thus, the DRB and the S1 bearer are brought into an unconnected state. Note that the S5 bearer is remained connected.

Update of Setting Information

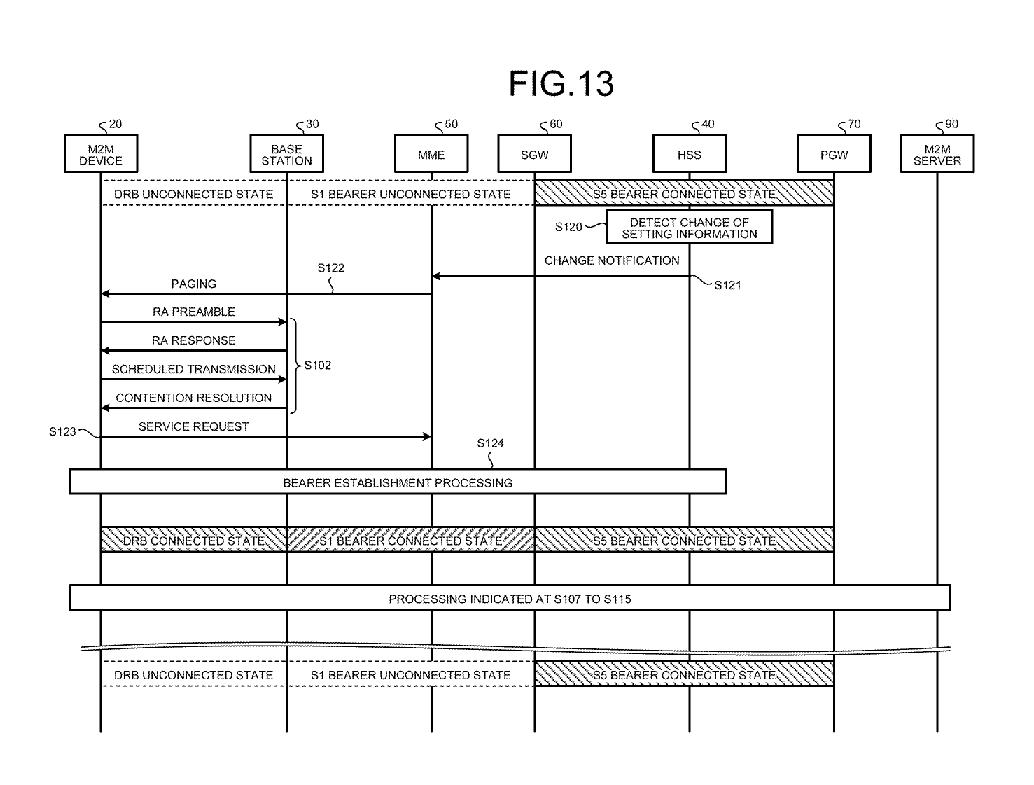

Next, operation of the wireless communication system 10 when setting information is updated is explained. FIG. 13 is a sequence diagram depicting one example of operation of the wireless communication system 10 at the time of updating setting information. In the present sequence diagram, processing starts in a state in which the attach processing is completed, the DRB and the S1 bearer are unconnected, and the S5 bearer is connected.

First, the HSS 40 detects a change in the setting information held therein (S120). The HSS 40 then transmits a change notification including the terminal identifier of the M2M device 20 for which the setting information has been changed (S121). The setting-information notifying unit 53 of the MME 50 establishes a bearer between itself and the M2M device that is identified by the terminal identifier included in the change notification.

Specifically, the MME 50 performs paging for the M2M device 20 through the base station 30 (S122). The M2M device 20 and the base station 30 then perform the initial access procedure explained in FIG. 12 (S102). The call control unit 22 of the M2M device 20 transmits a service request to the MME 50 through the base station 30 (S123). The bearer establish processing is performed among the M2M device 20, the base station 30, the MME 50, the SGW 60, and the HSS 40 (S124). In the bearer establishment processing, processing such as verification, concealment, and integrity control is also performed. Thus, the DRB is established between the M2M device 20 and the base station 30, and the S1 bearer is established among the base station 30, the MME 50, and the SGW 60.

The M2M device 20, the base station 30, and the MME 50 perform processing from steps S107 to S115 explained in FIG. 12. When user data communication has not occurred for a predetermined period between the M2M device 20 and the base station 30, the DRB and the S1 bearer are released again.

Connection Check Processing

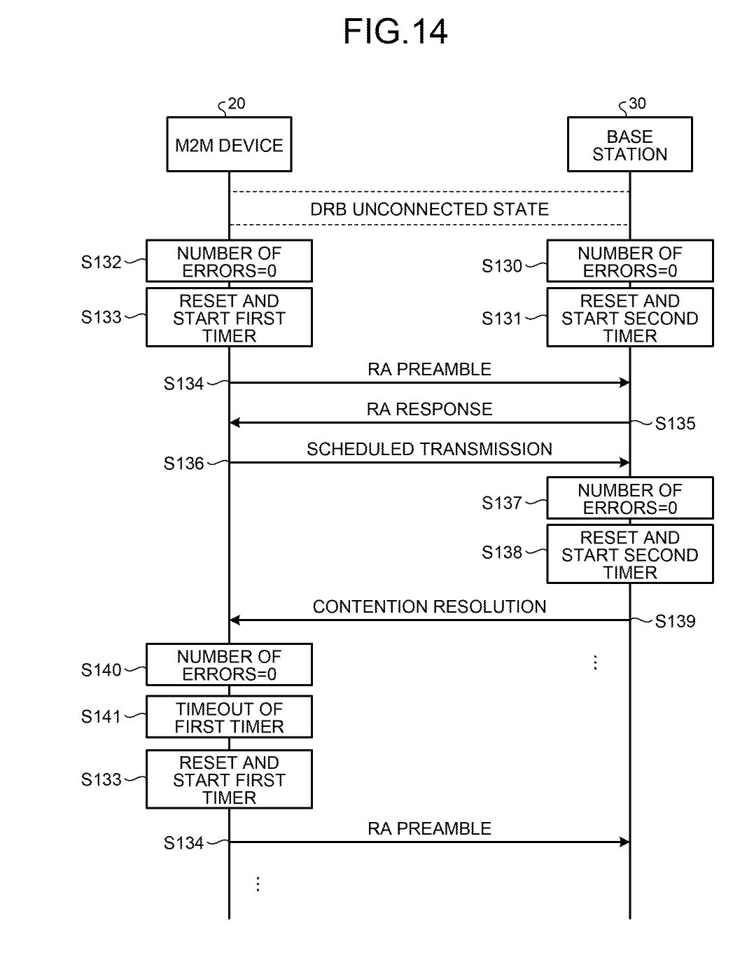

Next, operation of the wireless communication system 10 after the DRB between the M2M device 20 and the base station 30 is released is explained. FIG. 14 is a sequence diagram depicting one example of operation of the wireless communication system 10 in a DRB unconnected state. In the present sequence diagram, processing starts in a state in in which the attach processing is completed, the DRB and the S1 bearer are unconnected, and the S5 bearer is connected.

First, the call control unit 33 of the base station 30 informs the determining unit 34 of release of the bearers. The determining unit 34 resets the number of errors to 0 (S130), and resets and start the second timer (S131). The call control unit 22 of the M2M device 20 informs the determining unit 23 of release of the bearers. The determining unit 23 resets the number of errors to 0 (S132), and resets and starts the first timer (S133). Subsequently, the determining unit 23 instructs the check-signal transmitting unit 24 to transmit a check signal.

The check-signal transmitting unit 24 transmits RA Preamble to the base station 30 (S134). The call control unit 33 of the base station 30 transmits RA Response to the M2M device 20 as a response to RA Preamble (S135).

Subsequently, the check-signal transmitting unit 24 of the M2M device 20 transmits Scheduled Transmission including the terminal identifier of the M2M device 20 and the connection check identifier to the base station 30 (S136). When receiving Scheduled Transmission including the terminal identifier and the connection check identifier, the call control unit 33 of the base station 30 informs the determining unit 34 of reception of the check signal. The determining unit 34 resets the number of errors to 0 (S137) when informed of reception of the check signal by the call control unit 33 before the second timer times out, and resets and starts the second timer again (S138).

Scheduled Transmission including the terminal identifier and the connection check identifier is transmitted from the M2M device 20 as a response to RA Response transmitted from the base station 30. By receiving Scheduled Transmission including the terminal identifier and the connection check identifier, the call control unit 33 can determine that communication is enabled in both a wireless link from the M2M device 20 to the base station 30 and a wireless link from the base station 30 to the M2M device 20.

The call control unit 33 acquires the terminal identifier and the connection check identifier from received Scheduled Transmission. The call control unit 33 then transmits Contention Resolution that includes the terminal identifier and the connection check identifier acquired from Scheduled Transmission, to the M2M device 20 (S139).

When receiving Contention Resolution including the terminal identifier and the connection check identifier identical to the terminal identifier and the connection check identifier included in the Schedule Transmission, the check-signal transmitting unit 24 of the M2M device 20 informs the determining unit 23 of reception of a response signal. The determining unit 23 resets the number of errors to 0 (S140) when informed of reception of a response signal by the check-signal transmitting unit 24 before the first timer times out. When timeout of the first timer is detected (S141), the determining unit 23 resets and starts the first timer again (S133), and instructs the check-signal transmitting unit 24 to transmit a check signal. Thereafter, the processing at step S134 and after is repeated.

Reception of Contention Resolution that includes the terminal identifier and the connection check identifier identical to the terminal identifier and the connection check identifier included in transmitted Scheduled Transmission means that Scheduled Transmission has been received by the base station 30 successfully. Therefore, based on reception of Contention Resolution that includes the terminal identifier and the connection check identifier identical to the terminal identifier and the connection check identifier included in Scheduled Transmission, the determining unit 23 can determine that the wireless link between the M2M device 20 and the base station 30 is normal.

Operation of M2M Device when Abnormality in Wireless Connection is Detected

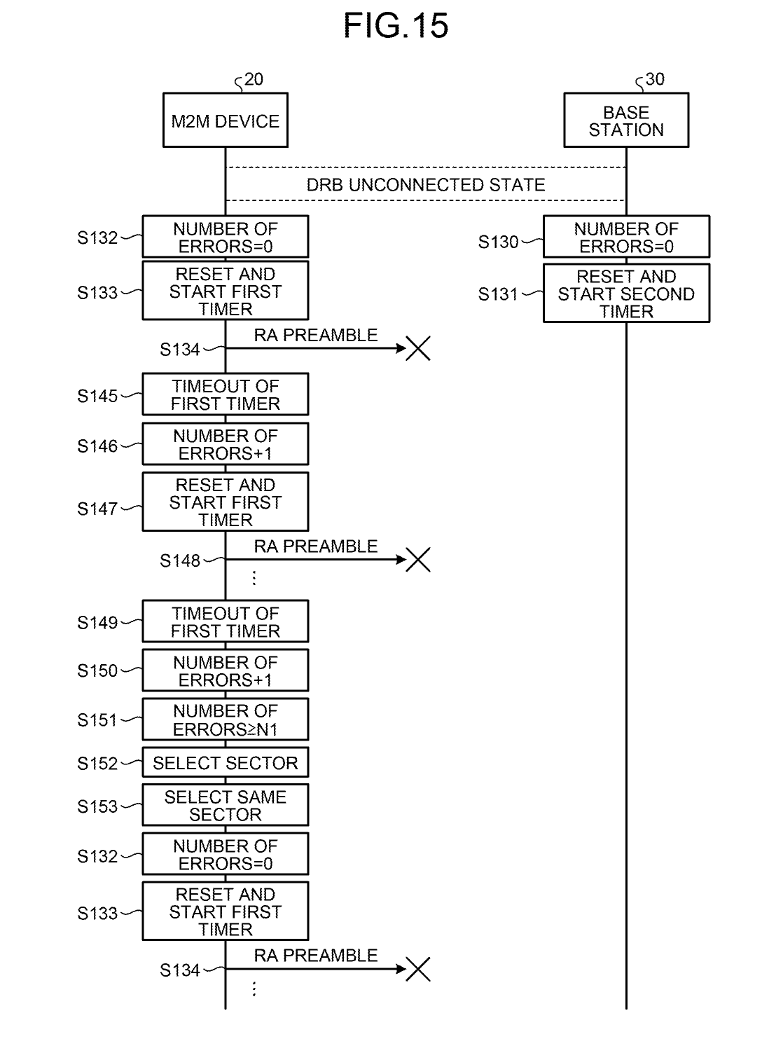

Next, operation of the wireless communication system 10 when an abnormality in the wireless connection between the M2M device 20 and the base station 30 is detected is explained. FIG. 15 is a sequence diagram depicting one example of operation of the M2M device 20 when an abnormality in wireless connection is detected. In the present sequence diagram, processing starts in a state in in which the attach processing is completed, the DRB and the S1 bearer are unconnected, and the S5 bearer is connected.

First, the call control unit 33 of the base station 30 informs the determining unit 34 of release of the bearers. The determining unit 34 resets the number of errors to 0 (S130), and resets and starts the second timer (S131). The call control unit 22 of the M2M device 20 informs the determining unit 23 of the release of the bearers. The determining unit 23 resets the number of errors to 0 (S132), and resets and starts the first timer (S133). The determining unit 23 then instructs the check-signal transmitting unit 24 to transmit a check signal. The check-signal transmitting unit 24 transmits RA Preamble to the base station 30 (S134).

If a shield or an interference wave is present in a wireless section between the M2M device 20 and the base station 30, it becomes difficult to connect the wireless link between the M2M device 20 and the base station 30, and RA Preamble transmitted from the M2M device 20 is not received normally. Therefore, a response signal such as Contention Resolution is not transmitted from the base station 30. Moreover, even if RA Preamble is normally received at the base station 30, if there is an abnormality in the wireless link of the downlink from the base station 30 to the M2M device 20, a response signal such as Contention Resolution transmitted from the base station 30 is not received by the call control unit 22. Therefore, the determining unit 23 can determine whether communication is enabled in both the wireless link from the M2M device 20 to the base station 30 and the wireless link from the base station 30 to the M2M device 20, by determine whether a response signal is received.

When detecting timeout of the first timer without being informed of reception of a response signal from the check-signal transmitting unit 24 (S145), the determining unit 23 increments the number of errors, for example, by 1 (S146). When the number of errors is less than the first threshold, the determining unit 23 resets and starts the first timer again (S147), and instructs the check-signal transmitting unit 24 to transmit a check signal. The check-signal transmitting unit 24 transmits RA Preamble to the base station 30 again (S148).

RA Preamble transmitted from the M2M device 20 does not reach the base station 30 due to an abnormality in the wireless section between the M2M device 20 and the base station 30. Therefore, the determining unit 23 is not to be informed of reception of a response signal by the check-signal transmitting unit 24, and detects timeout of the first timer again (S149), and increments the number of errors, for example, by 1 (S150). When detecting that the number of errors is equal to or more than N1, which is the first threshold (S151), the determining unit 23 instructs selection of a sector to the call control unit 22 (S152).

In the example depicted in FIG. 15, it is assumed that a different sector having a better signal quality than a cell being the transmission destination of RA Preamble at step S134 is not detected. Because a different sector is not detected, the call control unit 22 selects the same sector (S153). The call control unit 22 then informs the determining unit 23 that a different sector has not been selected. The determining unit 23 resets the number of errors to 0 (S132), and the memory 200 repeats the processing at S133 and after.

Operation of Base Station when Abnormality is Detected in Wireless Connection

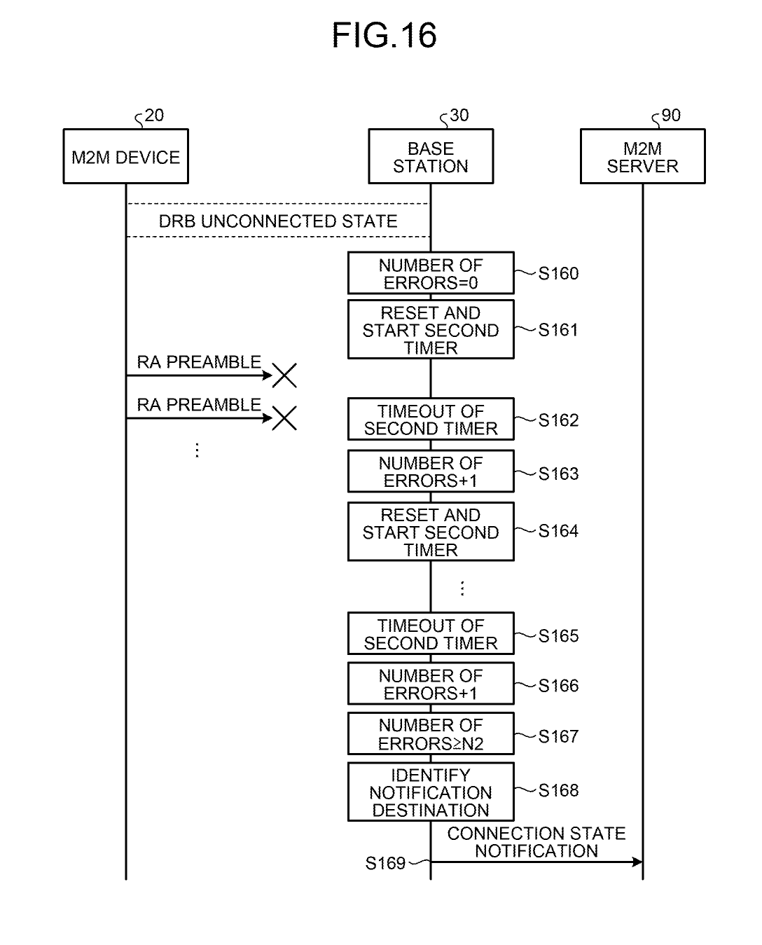

FIG. 16 is a sequence diagram depicting one example of operation of the base station 30 when an abnormality in wireless connection is detected. In the present sequence diagram, processing starts in a state in which the attach processing is completed, the DRB and the S1 bearer are unconnected, and the S5 bearer is connected.

First, the call control unit 33 of the base station 30 informs the determining unit 34 of release of the bearers. The determining unit 34 resets the number of errors to 0 (S160), and resets and starts the second timer (S161). When there is an abnormality in the wireless link between the M2M device 20 and the base station 30, a signal such as RA Preamble from the M2M device 20 is not normally received at the base station 30. Therefore, the determining unit 34 detects timeout of the second timer without being informed of reception of a check signal by the call control unit 33 (S162). The determining unit 34 increments the number of errors, for example, by 1 (S163). When the number of errors is less than the second threshold, the determining unit 34 resets and starts the second timer again (S164).

When timeout of the second timer is detected without being informed of reception of a check signal by the call control unit 33 (S165), the determining unit 34 increments the number of errors, for example, by 1 (S166). When the number of errors is equal to or more than N2 that is the second threshold (S167), the determining unit 34 informs the notifying unit 35 of abnormal connection together with the terminal identifier of the M2M device 20 being a subject of the connection check processing. The notifying unit 35 refers to the setting-information holding unit 36, and identifies a notification destination of a connection state notification (S168). Subsequently, the notifying unit 35 transmits the connection state notification that includes the terminal identifier and information indicating the abnormal connection, to the M2M server 90, which is the identified notification destination (S169).

Thus, the M2M server 90 can acquire information about the M2M device 20 for which an abnormality has occurred in the wireless link to the base station 30 promptly. The base station 30 can send the information about the M2M device 20 for which the abnormality has occurred in the wireless link to a predetermined notification destination promptly without performing processing to establish a DRB between itself and the M2M device 20. Thus, it is possible to avoid performing the processing to establish the DRB to detect the M2M device 20 for which an abnormality has occurred in the wireless link, thereby reducing a processing load on the base station 30.

Operation at Changing Sectors

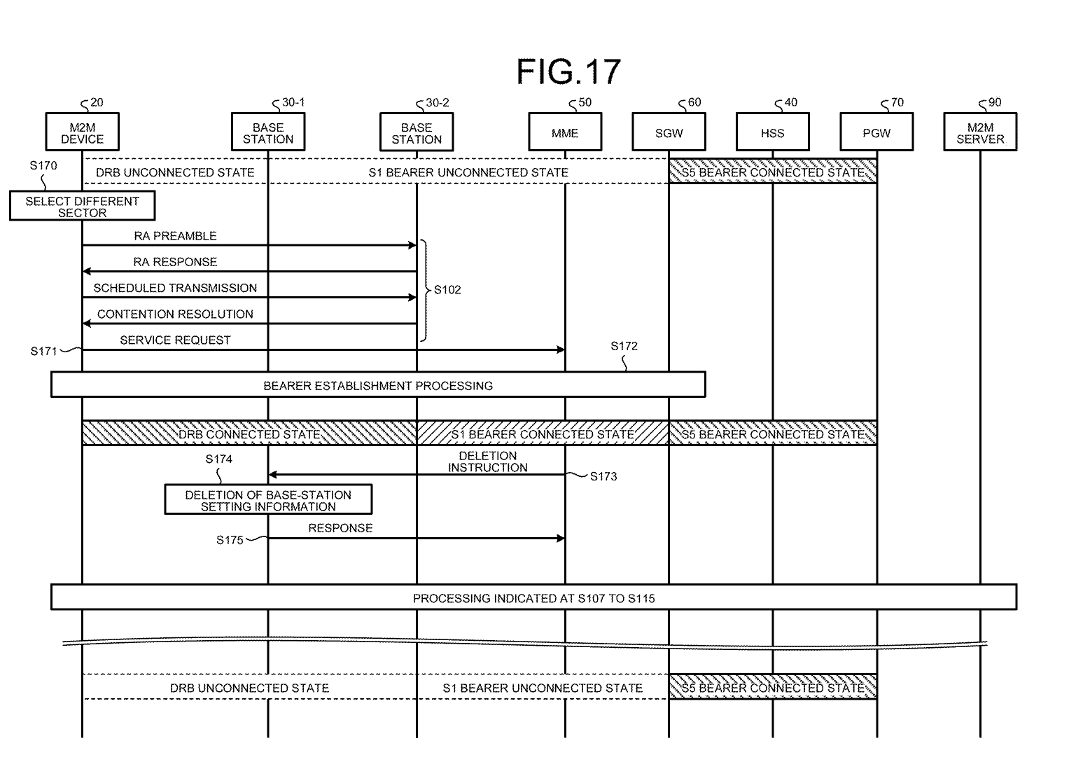

Next, operation of the M2M device 20 when a different sector is selected as a result of sector selection performed by the M2M device 20 is explained. FIG. 17 is a sequence diagram depicting one example of operation of the wireless communication system 10 when the M2M device 20 selects a different sector. In the present sequence diagram, processing starts in a state in which the attach processing is completed, the DRB and the S1 bearer are unconnected, and the S5 bearer is connected. Moreover, a base station 30-2 signifies the base station 30 having a different sector selected by the M2M device, and a base station 30-1 signifies the base station 30 having the sector that had been selected by the M2M device before the different sector is selected.

First, when the call control unit 22 of the M2M device 20 selects a different sector (S170), the initial access procedure explained using FIG. 12 is performed between the M2M device 20 and the base station 30-2 having the selected different sector (S102). The call control unit 22 of the M2M device 20 then transmits a service request to the MME 50 through the base station 30-2 having the different sector (S171). The bearer establishment processing is then performed among the M2M device 20, the base station 30-2, the MME 50, the SGW 60, and the HSS 40 (S172). In the bearer establishment processing at step S172, processing such as verification, concealment, and integrity control is also performed. Thus, the DRB is established between the M2M device 20 and the base station 30-2, and the S1 bearer is established among the base station 30-2, the MME 50, and the SGW 60.

Subsequently, the call control unit 52 of the MME 50 informs the terminal identifier of the M2M device 20 for which the bearer has been established and the base station identifier of the base station 30 to the setting-information notifying unit 53. The setting-information notifying unit 53 refers to setting information that is associated with the terminal identifier of the M2M device 20 for which the bearer has been established, and determines whether the base station identifier included in the setting information is identical to the base station identifier informed by the setting-information notifying unit 53. In the example depicted in FIG. 17, because the base station identifier of the base station 30-1 and the base station identifier of the base station 30-2 are different, the setting-information notifying unit 53 determines that the base station identifier included in the setting information and the base station identifier informed by the setting-information notifying unit 53 are different.

The setting-information notifying unit 53 then transmits a deletion instruction that includes the terminal identifier of the M2M device 20 informed by the call control unit 52, to the base station 30-1 that is identified by the base station identifier included in the setting information (S173). The call control unit 33 of the base station 30-1 deletes base-station setting information that is associated with the terminal identifier included in the deletion instruction that is received from the MME 50 from the setting-information holding unit 36 (S174). Subsequently, the call control unit 33 transmits a response indicating completion of deletion of the base-station setting information to the MME 50 (S175). The M2M device 20, the base station 30, and the MME 50 perform the processing from step S107 to step S115 explained in FIG. 12. When user data communication has not occurred for a predetermined time between the M2M device 20 and the base station 30, the DRB and the S1 bearer are released again.

Operation at Recovery of Wireless Connection

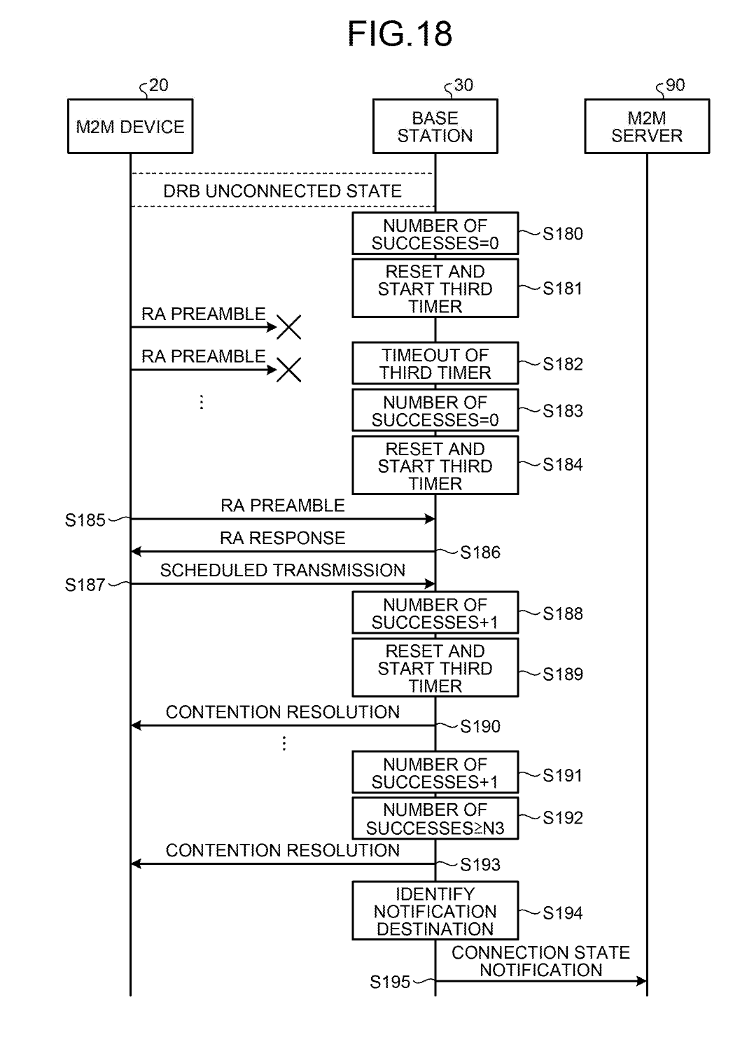

Next, operation of the wireless communication system 10 when recovery of wireless connection between the M2M device 20 and the base station 30 is detected is explained. FIG. 18 is a sequence diagram depicting one example of operation of the base station 30 when recovery of the wireless connection is detected. Processing in the present sequence diagram is performed, for example, following the processing depicted in FIG. 16.

First, the determining unit 34 of the base station 30 resets the number of successes, which indicates the number of times that the connection check processing is normally finished (S180), and resets and starts the third timer (S181). When not informed of reception of a check signal by the call control unit 33 before the third timer times out (S182), the determining unit 34 resets the number of successes to 0 (S183), and resets and starts the third timer again (S184).

Furthermore, when RA Preamble is received from the M2M device 20 (S185), the call control unit 33 transmits RA Response to the M2M device 20 (S186). When Scheduled Transmission that includes the terminal identifier of the M2M device 20 and the connection check identifier is received from the M2M device 20 (S187), the call control unit 33 informs the determining unit 34 of reception of a check signal. When the check signal is received from the call control unit 33 before the third timer times out, the determining unit 34 increments the number of successes, for example, by 1 (S188). The determining unit 34 then resets and starts the third timer again (S189).

The call control unit 33 acquires the terminal identifier and the connection check identifier from received Scheduled Transmission. The call control unit 33 then transmits Contention Resolution that includes the terminal identifier and the connection check identifier acquired from Scheduled Transmission to the M2M device 20 (S190).

When, as a result of incrementing the number of successes (S191), the number of successes becomes equal to or more than N3 that is the third threshold (S192), the determining unit 34 informs the notifying unit 35 of connection recovery together with the terminal identifier of the M2M device 20 that is the subject of the connection check processing. The call control unit 33 acquires the terminal identifier and the connection check identifier from received Scheduled Transmission, and transmits Contention Resolution that includes the acquired terminal identifier and connection check identifier to the M2M device 20 (S193).

The notifying unit 35 refers to the setting-information holding unit 36, and identifies the notification destination of the connection state notification (S194). Subsequently, the notifying unit 35 transmits the connection state notification that includes the terminal identifier and information indicating the connection recovery, to the M2M server 90 of the identified notification destination (S195).

Thus, the M2M server 90 can acquire information about the M2M device 20 for which wireless connection is recovered from an abnormality that has occurred in the wireless link to the base station 30, promptly. The base station 30 can inform information about the M2M device 20 for which the wireless link has been recovered from the abnormality to a predetermined notification destination promptly, without performing the processing to establish the DRB between itself and the M2M device 20. Thus, it is possible to avoid performing the processing to establish the DRB to detect the M2M device 20 for which a wireless link has been recovered from an abnormality, thereby reducing a processing load on the base station 30.

Operation of M2M Device

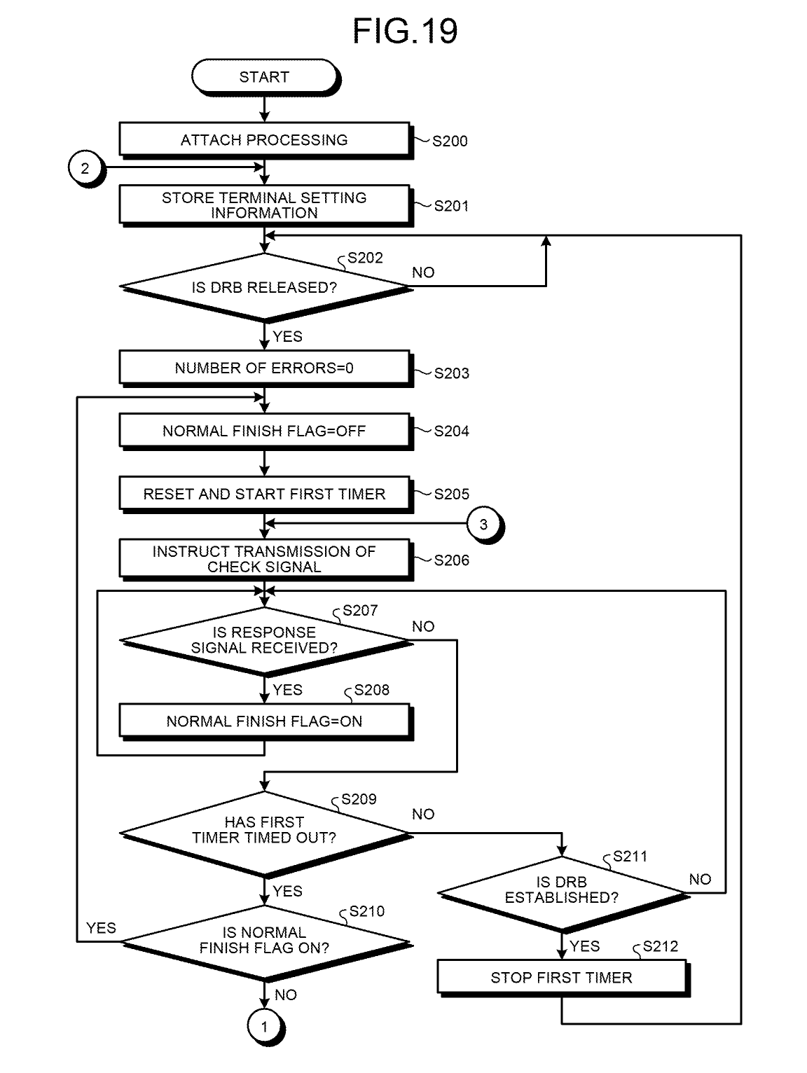

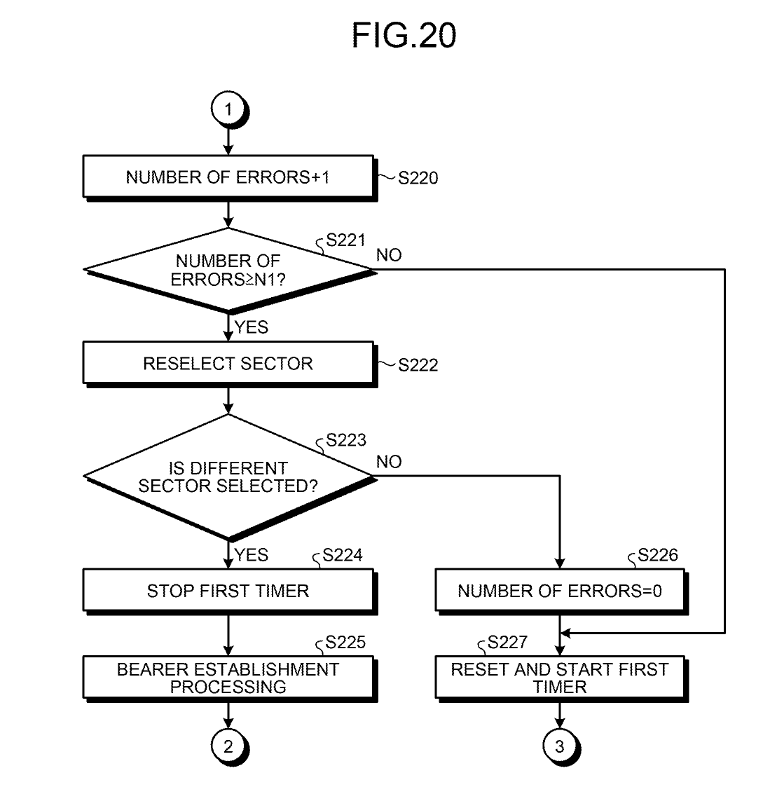

FIG. 19 and FIG. 20 are flowcharts indicating one example of operation of the M2M device 20. For example, upon power-up, the M2M device 20 starts the operation indicated in the present flowcharts.

First, the call control unit 22 selects a sector based on a notification information transmitted from a sector of the base station 30. The call control unit 22 then performs the attach processing between itself and MME 50 through the base station 30 having the selected sector (S200). The call control unit 22 receives terminal setting information from the base station 30 through the DRB established between itself and the base station 30, and stores the received terminal setting information in the setting-information holding unit 21 (S201).

Subsequently, the call control unit 22 determines whether the DRB is released (S202). For example, when user data communication with the base station 30 has not occurred for a predetermined period, the call control unit 22 releases the DRB. When the DRB is released (S202: YES), the call control unit 22 informs the determining unit 23 of release of the DRB. The determining unit 23 refers to the terminal setting information in the setting-information holding unit 21, and determines whether the execution flag is set to “ON”.

When the execution flag is set to “ON”, the determining unit 23 resets the number of errors to 0 (S203). The determining unit 23 sets a normal finish flag that is set to “ON” when the connection check processing executed between itself and the base station 30 is normally finished to “OFF” (S204). Subsequently, the determining unit 23 refers to the terminal setting information in the setting-information holding unit 21 to acquire the duration of the first timer, and resets and starts the first timer of the acquired duration (S205).

The determining unit 23 then instructs the check-signal transmitting unit 24 to transmit a check signal (S206). The check-signal transmitting unit 24 reads a sector identifier from the terminal setting information in the setting-information holding unit 21. The check-signal transmitting unit 24 transmits RA Preamble to the sector that is identified by the read sector identifier by wireless communication using a frequency that is used in the DRB between itself and the base station 30. When RA Response is received from the base station 30, the check-signal transmitting unit 24 transmits Scheduled Transmission that includes the terminal identifier of the M2M device 20 and the connection check identifier to the base station 30 as a check signal. When Contention Resolution that includes the terminal identifier of the M2M device 20 and the connection check identifier is received from the base station 30, the check-signal transmitting unit 24 informs the determining unit 23 of reception of a response signal.

Subsequently, the determining unit 23 determines whether it has been informed of reception of a response signal by the check-signal transmitting unit 24 (S207). When informed of reception of a response signal (S207: YES), the determining unit 23 sets the normal finish flag to “ON” (S208), and performs the processing indicated at step S207 again.

On the other hand, when not informed of a reception of a response signal (S207: NO), the determining unit 23 determines whether the first timer has timed out (S209). When the first timer has not timed out (S209: NO), the call control unit 22 determines whether the DRB is established due to occurrence of user data communication and the like (S211). When the DRB is not established (S211: NO), the determining unit 23 performs the processing indicated at step S207 again. On the other hand, when the DRB is established (S211: YES), the call control unit 22 informs the determining unit 23 of establishment of the DRB. The determining unit 23 stops the first timer (S212). Subsequently, the call control unit 22 performs the processing indicated at step S202 again.

When the first timer times out (S209: YES), the determining unit 23 determines whether the normal finish flag is set to “ON” (S210). When the normal finish flag is set to “ON” (S210: YES), the determining unit 23 performs the processing indicated at step S204 again.

On the other hand, when the normal finish flag is set to “OFF” (S210: NO), the determining unit 23 increments the number of errors by 1 (S220 indicated in FIG. 20). The determining unit 23 determines whether the number of errors is equal to or more than N1 that is the first threshold (S221). When the number of errors is less than the first threshold (S221: NO), the determining unit 23 resets and starts the first timer (S227), and performs the processing indicated at step S206 in FIG. 19 again.

On the other hand, when the number of errors is equal to or more than the first threshold (S221: YES), the determining unit 23 instructs reselection of a sector to the call control unit 22 (S222). Subsequently, the determining unit 23 determines whether a different sector is selected by the call control unit 22 (S223). When a different sector is not selected by the call control unit (S223: NO), the determining unit 23 resets the number of errors to 0 (S226), and performs the processing indicated at step S227. On the other hand, when a different sector is selected by the call control unit 22 (S223: YES), the determining unit 23 stops the first timer (S224). The call control unit 22 then establishes a bearer between itself and the MME 50 through the base station 30 that has selected the different sector (S225), and performs the processing indicated at step S201 again.

Operation of Base Station

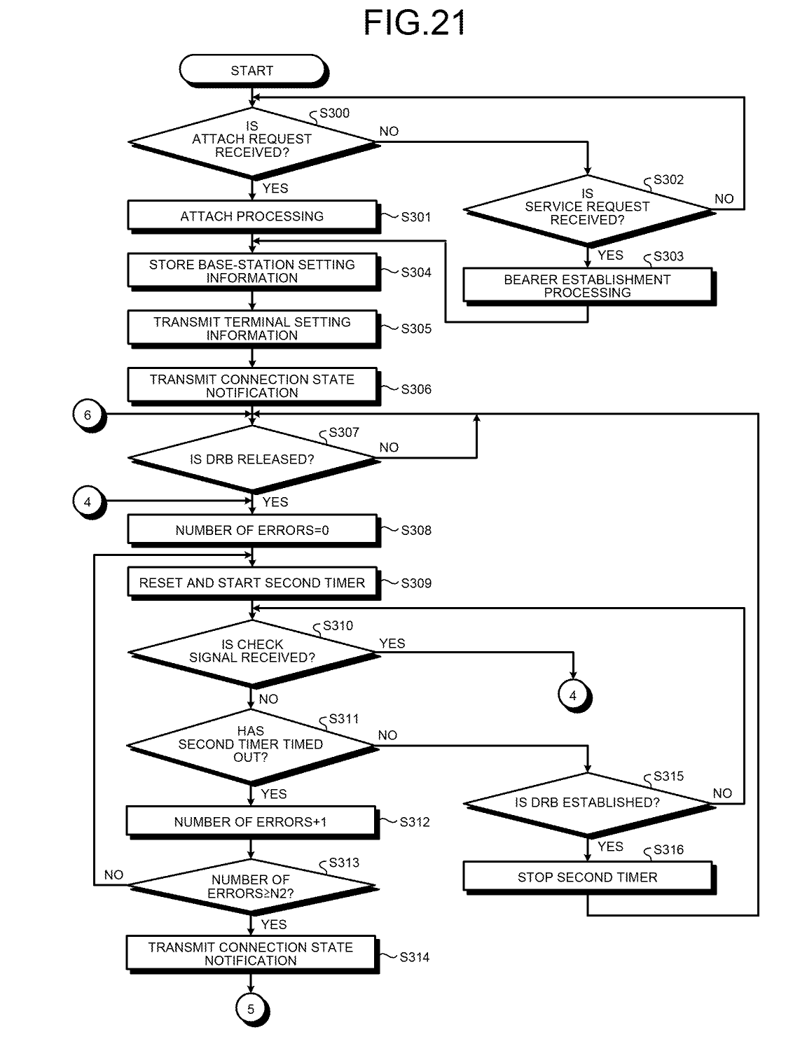

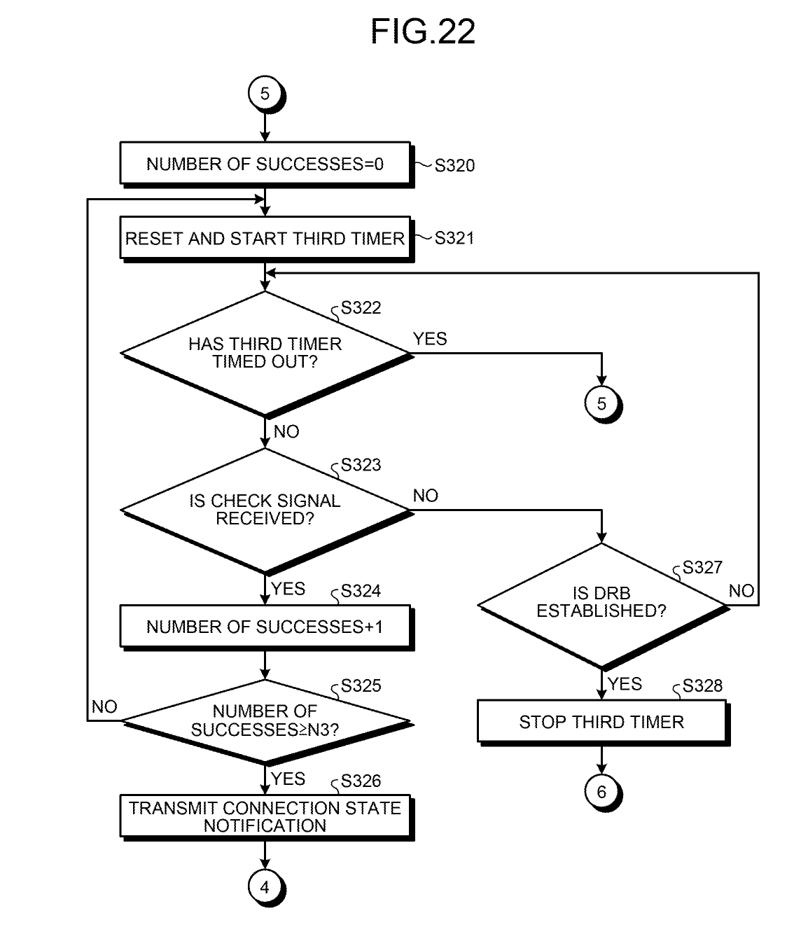

FIG. 21 and FIG. 22 are flowcharts indicating one example of operation of the base station 30. With predetermined processing such as power-up, the base station 30 starts the operation indicated in the present flowchart. In the present flowchart, processing of the base station 30 for a single unit of the M2M device 20 is indicated. When multiple units of the M2M devices 20 communicate through the base station 30, the base station 30 performs the processing indicated in FIG. 21 and FIG. 22 for each of the M2M devices 20.

First, the call control unit 33 determines whether an attach request is received from the M2M device 20 (S300). When receiving an attach request (S300: YES), the call control unit 33 performs the attach processing among the M2M device 20, the MME 50, the SGW 60, HSS 40, and the PGW 70 (S301). The attach processing includes processing such as verification, concealment, integrality control, position registration, and bearer establishment. The call control unit 33 performs the processing indicated at step S304.

When an attach request is not received (S300: NO), the call control unit 33 determines whether a service request is received (S302). When a service request is not received (S302: NO), the call control unit 33 performs the processing indicated at step S300 again. When a service request is received (S302: YES), the call control unit 33 performs the bear establishment processing among the M2M device 20, the MME 50, the SGW 60, and the HSS 40 (S303). At step S303, processing such as verification, concealment, and integrity control is also performed.

Subsequently, the call control unit 33 receives setting information from the MME 50 through the S1 bearer. The call control unit 33 stores base-station setting information included in the received setting information, in the setting-information holding unit 36 (S304). Subsequently, the call control unit 33 transmits terminal setting information that is included in the setting information received from the MME 50 to the M2M device 20 through the DRB (S305).

The call control unit 33 informs the notifying unit 35 of establishment of the bearer together with the terminal identifier of the M2M device 20 for which the bearer is established. The notifying unit 35 refers to the setting-information holding unit 36, and identifies base-station setting information that is associated with the terminal identifier informed by the call control unit 33. The notifying unit 35 then transmits a connection state notification that indicates that the bearer is established to the device identified by the notification destination that is included in the identified base-station setting information through the wired communication unit 37 (S306).

Subsequently, the call control unit 33 determines whether the DRB is released (S307). When the DRB is released (S307: YES), the call control unit 33 informs the determining unit 34 of release of the bearer. The determining unit 34 reads the base-station setting information that is associated with the terminal identifier of the M2M device for which the bearer has been released, from the setting-information holding unit 36. When the execution flag is set to “ON” indicating execution of the connection check processing, the determining unit 34 resets the number of errors to 0 (S308). The determining unit 34 then resets and starts the second timer having duration set in the base-station setting information read from the setting-information holding unit 36 (S309).

Subsequently, the determining unit 34 determines whether reception of a check signal is informed by the call control unit 33, thereby determining whether a check signal is received (S310). When a check signal is received (S310: YES), the determining unit 34 performs the processing indicated at step S308 again.

On the other hand, when a check signal is not received (S310: NO), the determining unit 34 determines whether the second timer has timed out (S311). When the second timer has not timed out (S311: NO), the call control unit 33 determines whether the DRB is established due to occurrence of user data communication and the like (S315). When the DRB is not established (S315: NO), the determining unit 34 performs the processing indicated at step S310 again. On the other hand, when the DRB is established (S315: YES), the call control unit 33 informs the determining unit 34 of establishment of the DRB. The determining unit 34 stops the second timer (S316). The call control unit 33 performs the processing indicated at step S307 again.

When the second timer has timed out (S311: YES), the determining unit 34 increments the number of errors by (S312), and determines whether the number of errors is equal to or more than N2 that is the second threshold (S313). When the number of errors is less than the second threshold (S313: NO), the determining unit 34 performs the processing indicated at step S309 again.

On the other hand, when the number of errors is equal to or more than the second threshold (S313: YES), the determining unit 34 informs abnormal connection to the notifying unit 35 together with the terminal identifier of the M2M device 20. The notifying unit 35 refers to the setting-information holding unit 36, and identifies base-station setting information that is associated with the terminal identifier informed by the determining unit 34. Subsequently, the notifying unit 35 transmits a connection state notification indicating the abnormal connection to the device identified by the notification destination included in the identified base-station setting information through the wired communication unit 37 (S314).

Subsequently, the determining unit 34 resets the number of successes to 0 (S320 in FIG. 22). Moreover, the determining unit 34 resets and starts the third timer having duration set in the base-station setting information read from the setting-information holding unit 36 (S321). The determining unit 34 determines whether the third timer has timed out (S322). When the third timer has timed out (S322: YES), the determining unit 34 performs the processing indicated at step S320 again.

On the other hand, when the third timer has not timed out (S322: NO), the determining unit 34 determines whether a reception of a check signal is informed by the call control unit 33, thereby determining whether a check signal is received (S323). When a check signal is not received (S323: NO), the call control unit 33 determines whether the DRB is established due to occurrence of user data communication and the like (S327). When the DRB is not established (S327: NO), the determining unit 34 performs the processing indicated at step S322 again. On the other hand, when the DRB is established (S327: YES), the call control unit 33 informs the determining unit 34 of establishment of the DRB. The determining unit 34 stops the third timer (S328). The call control unit 33 performs the processing indicated at step S307 again.

On the other hand, when a check signal is received (S323: YES), the determining unit 34 increments the number of successes by 1 (S324), and determines whether the number of successes is equal to or more than N3 that is the third threshold (S325). When the number of successes is less than the third threshold (S325: NO), the determining unit 34 performs the processing indicated at step S321 again. On the other hand, when the number of successes is equal to or more than the third threshold (S325: YES), the determining unit 34 informs the notifying unit 35 of connection recovery together with the terminal identifier of the M2M device 20. The notifying unit 35 refers to the setting-information holding unit 36, and identifies base-station setting information that is associated with the terminal identifier informed by the determining unit 34. Subsequently, the notifying unit 35 transmits a connection state notification indicating the connection recovery to the device that is identified by the notification destination included in the identified base-station setting information through the wired communication unit 37 (S326). The determining unit 34 performs the processing indicated at step S308 again.

The embodiments have been explained as above. As described above, the check-signal transmitting unit 24 transmits Scheduled Transmission to the base station 30 every first period, by wireless communication using a frequency used in a bearer after the bearer in a wireless section between itself and the base station 30 is released. Moreover, the determining unit 34 of the base station 30 determines whether there is an abnormality in wireless connection to the M2M device 20 based on whether Scheduled Transmission is received from the M2M device 20 within the second period. Furthermore, when it is determined that there is an abnormality in the wireless connection between itself and the M2M device 20 by the determining unit 34, the notifying unit 35 informs a predetermined notification destination of the abnormality. Thus, the wireless communication system 10 of the present embodiment can detect the abnormality in wireless connection between the base station 30 and the M2M device 20 promptly, suppressing increase of a processing load on the base station.

Moreover, as described above, the call control unit 33 of the base station 30 transmits RA Response as a response to RA Preamble that is transmitted from the M2M device 20. The call control unit 22 of the M2M device 20 transmits Scheduled Transmission as a response to RA Response transmitted from the base station 30. Thus, the determining unit 34 can determine whether communication is enabled in both in a wireless link from the M2M device 20 to the base station 30 and a wireless link from the base station 30 to the M2M device 20.

Furthermore, as described above, when the M2M device 20 and the base station 30 perform the attach processing, the setting-information notifying unit 53 of the MME 50 informs setting information that includes information indicating a notification destination to the base station 30 that has performed the attach processing. Moreover, when it is determined that there is an abnormality in a wireless connection between itself and the terminal by the determining unit 34, the notifying unit 35 of the base station 30 notifies the notification destination indicated by the information included in the setting information informed by the MME 50. Thus, the notifying unit 35 can identify the notification destination easily when it is determined that there is an abnormality in wireless connection.

Moreover, as described above, the call control unit 33 of the base station 30 adds an identifier of a sector of the base station 30 to terminal setting information that is included in the setting information received from the MME 50, to transmit to the M2M device 20. The check-signal transmitting unit 24 of the M2M device 20 transmits a check signal to the sector corresponding to the terminal setting information received from the base station 30. Thus, the processing of selecting a sector before transmission of a check signal can be omitted, and a processing load on the M2M device 20 can be reduced.

Furthermore, as described above, the call control unit 33 of the base station 30 transmits Contention Resolution to the M2M device 20 as a response to Scheduled Transmission. The determining unit 23 of the M2M device 20 determines whether there is an abnormality in wireless connection to the base station 30 based on whether Contention Resolution is received from the base station 30 within the first period after transmission of the check signal by the check-signal transmitting unit 24. When it is determined that there is an abnormality in the wireless connection to the base station by the determining unit 23, the call control unit 22 of the M2M device 20 searches for the different base station 30. The call control unit 22 then establishes a bearer between itself and the searched different base station 30. The setting-information notifying unit 53 of the MME 50 informs base-station setting information associated with the M2M device 20 to the different base station 30 when the bearer is established between the M2M device 20 and the different base station 30. The setting-information notifying unit 53 then instructs deletion of the base-station setting information associated with the M2M device 20, to the base station 30 for which a bearer has been established by the M2M device 20 before the different base station 30. Thus, when the M2M device 20 selects a sector of the different base station 30 after the DRB between the M2M device 20 and the base station 30 is released, the connection check processing can be performed succeedingly between itself and the different base station 30.

### Modification

The technique disclosed in the present application is not limited to each embodiment described above, but various modifications can be applied within a range of the gist.

For example, although explanation has been given with the M2M device 20 as one example of a terminal that performs wireless communication with the base station 30 in the embodiments described above, the disclosed technique is not limited thereto. For example, as a terminal that performs wireless communication with the base station 30, the disclosed technique is applicable to a wireless communication system having a mobile phone, a smartphone, a tablet terminal, an in-car communication terminal, and the like instead of the M2M device 20.

Furthermore, for example, when the M2M device 20 and the base station 30 have a carrier aggregation function, the terminal setting information may include information about a part of component carriers among multiple component carriers used in carrier aggregation. The M2M device 20 transmits a check signal by using a component carrier identified by information included in the terminal setting information, in the connection check processing after release of the DRB. The information about a component carrier that is used in the connection check processing is set, for example, by the base station 30 or a device at a higher level than the base station 30 (for example, the MME 50 and the like).

Thus, when more than one unit of the M2M device 20 transmits a check signal to a single unit of the base station 30, it is possible to vary a component carrier that is used in transmission of the check signal among the M2M devices 20. Accordingly, the component carriers used in transmission of the check signal can be distributed, and the possibility of collision of the check signals among the M2M devices 20 can be reduced. Moreover, by avoiding concentration of the check signals to a specific component carrier, an influence to other terminals that uses the specific component can be reduced.

Although setting information is stored in the HSS 40 and the setting-information notifying unit 53 of the MME 50 acquires the setting information from the HSS 40 at the time of the attach processing or the bearer establishment processing in the above embodiments, the disclosed technique is not limited thereto. The setting information may be stored in a device other than the HSS 40, such as the MME 50 and the base station 30.

Furthermore, although setting information is transmitted from the MME 50 to the base station when the attach processing or the bearer establishment processing are performed in the M2M device 20 and the base station 30, and terminal setting information is transmitted from the base station 30 to the M2M device 20 in the above embodiments, the disclosed technique is not limited thereto. For example, setting information may be transmitted from the MME 50 to the base station 30 and terminal setting information may be transmitted from the base station 30 to the M2M device 20 through a bearer that is established when the M2M device 20 performs position registration processing.

Moreover, in the above embodiments, when the number of times that a check signal is not received from the M2M device 20 before the second timer times out after the DRB is released reaches the second threshold or more, the base station 30 transmits a notification indicating abnormal connection to a predetermined notification destination. However, the disclosed technique is not limited thereto. For example, in a device other than the base station 30 such as the MME 50 and the PGW 70 (hereinafter, a different device), information about a notification destination is stored associating with the terminal identifier of the M2M device 20. When the number of times that a check signal is not received from the M2M device 20 before the second timer times out reaches the second threshold or more after release of the DRB, the base station 30 transmits the terminal identifier of the M2M device 20 and information indicating the abnormal connection to the different device. It may be configured such that the different device transmits a connection state notification indicating the abnormal connection to the notification destination associated with the terminal identifier.

Furthermore, respective functional blocks in the M2M device 20, the base station 30, and the MME 50 are ones classified per function according to the main processing, to facilitate understanding of functions of devices according to the present embodiment. Therefore, the disclosed technique is not to be limited by a classification method and names of the functional blocks. Moreover, the M2M device 20, the base station 30, and the MME 50 according to the present embodiments can be classified into more functional blocks, or can be classified such that one functional block performs more kinds of processing. Furthermore, each processing may be implemented as processing by software, or may be implemented by dedicated hardware such as an application specific integrated circuit (ASIC).

According to one embodiment, abnormality in wireless connection between a base station and a terminal can be promptly detected, suppressing the increase of a processing load on the base station.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A wireless communication system comprising:
a terminal; and
a base station that performs wireless communication with the terminal, wherein
the terminal includes
a first transmitting unit that transmits, after a bearer between the terminal and the base station is released, a check signal to the base station every first period by wireless communication using a frequency that is used in the bearer, and
the base station includes
a first determining unit that determines whether there is an abnormality in wireless connection to the terminal based on whether the check signal is received from the terminal within a second period after the bearer is released, and
a first notifying unit that notifies, when the first determining unit determines that there is an abnormality in the wireless connection to the terminal, the abnormality to a predetermined notification destination.

2. The wireless communication system according to claim 1, wherein
the base station includes
a second transmitting unit that transmits a first signal, and
the first transmitting unit transmits the check signal to the base station as a response to the first signal transmitted from the base station.

3. The wireless communication system according to claim 2, further comprising
a management unit that includes
a second notifying unit that notifies, when the terminal and the base station performs attach processing, setting information including information that indicates the notification destination to the base station that performs the attach processing, wherein
the first notifying unit notifies, when the first determining unit determines that there is an abnormality in the wireless connection to the terminal, the abnormality to the notification destination indicated by information included in the setting information that is notified by the management unit.

4. The wireless communication system according to claim 3, wherein
the second transmitting unit adds information indicating a sector of the base station to the setting information received from the management unit, to transmit to the terminal, and
the first transmitting unit transmits the check signal to the sector indicated by the information included in the setting information that is received from the base station.

5. The wireless communication system according to claim 3, wherein
the setting information includes information that indicates a component carrier through which the check signal is transmitted, among a plurality of component carriers used in carrier aggregation,
the second transmitting unit transmits the setting information received from the management unit to the terminal, and
the first transmitting unit transmits the check signal using the component carrier that is indicated by the information included in the setting information that is received from the base station.

6. The wireless communication system according to claim 3, wherein
the second transmitting unit transmits a response signal to the terminal as a response to the check signal,
the terminal includes
a second determining unit that determines whether there is an abnormality in wireless connection to the base station based on whether the response signal is received from the base station within the first period after the first transmitting unit transmits the check signal;
a searching unit that searches for a different sector when the second determining unit determines that there is an abnormality in the wireless connection to the base station; and
a bearer-establishment processing unit that establishes the bearer through the different sector searched by the searching unit, and
the second notifying unit notifies the setting information corresponding to the terminal, to the base station having the different sector when the bearer is established through the different sector, and instructs deletion of the setting information corresponding to the terminal, to the base station having the sector through which the terminal established the bearer before the different sector.
